(19) United States
(12) Patent Application Publication
(10) Pub. No.: US 2008/0231953 A1
(43) Pub. Date: Sep. 25, 2008

(54) System and Method for LED Polarization Recycling

(76) Inventor: Garrett J. Young, Oskaloosa, IA (US)

Correspondence Address: SCHWEGMAN, LUNDBERG & WOESSNER, P.A., P.O. BOX 2938, MINNEAPOLIS, MN, 55402, US

(21) Appl. No.: 11/941,707

(22) Filed: Nov. 16, 2007

Related U.S. Application Data
(60) Provisional application No. 60/896,306, filed on Mar. 22, 2007.

(51) Int. Cl. G02B 27/28

(52) U.S. Cl. 359/495

(57) ABSTRACT

Systems and methods for creating high-intensity, polarized light, where one or more embodiments of the present invention use light polarization recycling to allow multiple light sources of the same or different wavelengths to be combined into a single source output where the individual source etendue is equal or substantially similar to the combined source etendue.

This application claims the benefit of provisional patent application No. 60/896,306, filed Mar. 22, 2007, which is incorporated herein in its entirety by reference.

### I. BACKGROUND OF THE INVENTION

A. Field of the Invention

Embodiments of the present invention relate to systems and methods for creating high-intensity, polarized light, where one or more embodiments of the present invention allow multiple light sources of the same or different wavelengths to be combined into a single combined source where the etendue of each individual source is equal or at least substantially similar to the etendue of the combined source.

B. Background

Optical systems that operate on the principle of polarization and polarization rotation require specifically polarized light to operate efficiently. Typically when dealing with these systems, the convention that is adopted is to refer to the orthogonal components of polarization as S and P polarizations. The S and P convention will be used throughout this document to describe the specific polarization states being discussed.

Emission from light sources, such as incandescent, gas discharge, or solid state such as light emitting diodes (LEDs), is generally characterized as randomly polarized light. In order to use these light sources in systems involving polarization dependent optics, the randomly polarized light typically needs to be converted into a singularly (or substantially singularly) polarized state. Many common methods exist to generate singularly polarized light, such as utilizing a polarizing beam splitter (PBS) to reflect one state of polarization to the device (e.g., the S component of the light) and allowing the opposite unusable state of polarization to pass through and be wasted (e.g., the P component of the light). Thus, these types of methods are inefficient uses of the initial source output, generally only reaching 50% (or less) utilization of light from each light source.

Some recent methods pursuing higher efficiency from light sources involve converting (i.e., “recycling”) the otherwise unusable, previously wasted state of polarization into the usable state of polarization and directing this now-usable light toward the target area. These methods improve efficiency to some degree but do not conserve the etendue of the light source. Etendue is a technical term that in French literally means “extent.” For optical systems, it is used to characterize how “spread out” the light is in terms of the source area and angular emission of the source. Etendue is typically calculated by taking the product of the source area and the solid angle of emission for the source area.

An example of a system of polarized recycling that also increases etendue is shown in FIG. 1. The P component is the desired state of polarization for this example. Referring to FIG. 1, light source 2 emits light R (randomly polarized light) to the polarizing beam splitter (PBS) 80. The P component, shown as P1, is passed through PBS 80 and the S component, shown as S1, is reflected. The reflected S1 is sent to mirror 70 positioned at an angle (here 45 degrees) to reflect S1 into a parallel path to P1. The reflected S1 light off mirror 70 passes through ½ wave retarder 51, which phase shifts the light 180 degrees, thereby converting the light to P polarization, shown as P2. The result is improved output efficiency due to polarization recycling. However the output area that the light exits from had doubled, which also means the etendue of the usable light has increased. This is because P1 and P2 create two different outputs that are equal to the area of two sources. A challenge faced by many designers is how to manage the etendue of their system or application in order to achieve high optical efficiencies within the required mechanical dimensions. Many applications, such as digital projection devices are limited to a given maximum etendue (i.e., the etendue is fixed because of a fixed area and light acceptance angle). While it may be conceptually desirable to increase the total flux of the light available to the system by adding additional sources, or by conventional polarized light recycling techniques, these efforts will generally result in undesirably increasing the etendue of the source. Thus, while the polarization recycling method shown in the example of FIG. 1 may increase the efficiency of delivering the desired polarized light component to the optical system, the etendue of the polarized light in that example is unfavorably increased due to the increased source area.

A system that can be used to combine light sources with different wavelengths is shown in FIG. 2. Referring to FIG. 2, three light sources of different wavelengths can be utilized, such as red, green, and blue, and combined together by a prism (x-cube) 110 with dichroic coatings to reflect a range of wavelengths and allow wavelengths outside the range to pass through.

The system shown in FIG. 2 is effective in combining light without increasing the resulting light source. However, a disadvantage of this system is that it requires the light sources to be of substantially different wavelengths in order to be able to combine them together into a single source with the same etendue. This is due to the nature of the reflective/transmissive dichroics used in the x-cube 110 and their internal positioning, making it unworkable if light of substantially similar wavelength were used. In addition, where polarized light is needed, it can be appreciated that the system shown in FIG. 2 does not, itself, yield polarized light where the input into the system is randomly polarized. Therefore, where a randomly polarized light source (typical of digital projection systems) is used, and where light going into (or coming from) the x-cube is polarized by conventional (non-recycling) polarizing means to accommodate applications requiring polarized light, half of the light will be wasted. If a polarizing/recycling mechanism such as the one in FIG. 1 is used, then as mentioned above, etendue will not be conserved.

As a consequence, there is room for alternative solutions having increased efficiency in producing the desired polarization state in the light output, reducing energy consumption while maintaining lighting performance levels, and preserving the etendue of the initial light source when combining sources. The present invention speaks to such solutions of converting light into efficient, polarized light through means of light recycling.

### II. BRIEF SUMMARY OF THE INVENTION

Embodiments of the present invention relate to systems and methods for creating high-intensity, polarized light, where one or more embodiments of the present invention use light polarization recycling to allow multiple light sources of the same or different wavelengths to be combined into a single source output where the individual source etendue is equal or substantially similar to the combined source etendue. Various embodiments of the present invention can be used with (as well as incorporate) illumination and imaging components/systems such as video projection systems.

More specifically, in one or more embodiments contemplated by the present invention, randomly polarized light R generated from one or more LED light sources is converted into one state of polarization by separating the two orthogonal polarized components (S and P), sending a first state of polarization to a light receiving environment and recycling the opposite second state by passing the unused portion through, e.g., retarders, to phase shift the light to the first state of polarization for then sending to the light receiving environment. It is envisioned that components are positioned such that the LED light source(s) reflects light that it (and/or other LED light sources) initially generated.

As one example envisioned by embodiments of the present invention, a randomly polarized light from the one or more light sources can be directed through a ¼ wave retarder (with the fast axis rotated 45 degrees to the plane of polarization). The light exiting the ¼ wave retarder is still considered to be randomly polarized with phase shifts of 90 degrees from the original source.

After passing through the ¼ wave retarder, the light is directed to a polarizing beam splitter (PBS) to separate the two randomly polarized components, reflecting one component (e.g., the S component) and transmitting the opposite component (e.g., the P component), depending upon the nature of the PBS. A mirror located opposite the LED source reflects the P component back through the PBS and the ¼ wave retarder (converting the P component to circularly polarized light, referred to as a circular P component) and back to the LED. The LED acts like a mirror and directs the converted circular P component from substantially the same point and in substantially the same direction as the initial light. The second pass of the light through the ¼ wave retarder converts the circular P component to an S component, which is then reflected by the PBS to the light receiving environment. Of course, this can also be reversed, i.e., conversion from S to P components, by using a PBS that reflects P and passes S. A similar situation exists and should be evident in various other examples below.

Utilizing an LED with or without an optic assembly as a reflective source, instead of (or in addition to) mirrors, one or more embodiments of the present invention envision that multiple LEDs can be used to increase the total output of light containing the desired polarization state, with little or no increase in the etendue of the light output. These LEDs can be connected to provide a single source of light with a higher total flux containing the desired polarization state with an equal or substantially similar etendue to an individual source. The result is an increase in luminance from the optical source. An increase in source luminance provides for an increase in brightness of the projected image.

### III. BRIEF DESCRIPTION OF THE DRAWINGS

FIG. 1 is a diagram of related art used for polarization recycling using a polarized beam splitter.

FIG. 2 is a diagram of related art used to combine light of different wavelengths into single source using a dichroic prism.

FIG. 3 is a legend depicting components contemplated by various embodiments of the present invention illustrated in various figures herein.

FIG. 4A is a diagram depicting light polarization recycling utilizing dual LED sources as contemplated by embodiments of the present invention.

FIGS. 4B-C are line diagrams of polarized light paths from each LED light source as illustrated in FIG. 4A

FIGS. 4D-E are flow diagrams of polarized light paths from each LED light source as illustrated in FIG. 4A

FIG. 5A is a diagram depicting light polarization recycling utilizing three LED sources as contemplated by embodiments of the present invention.

FIGS. 5B-D are line diagrams of polarized light paths from each LED light source as illustrated in FIG. 5A.

FIGS. 5E-G are flow diagrams of polarized light paths from each LED light source as illustrated in FIG. 5A

FIG. 6 is an enlarged cross-sectional view of an LED light source with reflective substrate as contemplated by embodiments of the present invention.

FIG. 7A is a diagram depicting light polarization recycling utilizing a dual LED source with ½ wave retarders over a portion of the light source as contemplated by embodiments of the present invention.

FIGS. 7B-C are line diagrams of polarized light paths from each LED light source as illustrated in FIG. 7A

FIGS. 7D-G are flow diagrams of polarized light paths from each LED light source as illustrated in FIG. 7A

FIG. 8A is a diagram depicting light polarization recycling utilizing a three LED light source.

FIGS. 8B-D are line diagrams of polarized light paths from each LED light source as illustrated in FIG. 8A

FIGS. 8E-J are flow diagrams of polarized light paths from each LED light source as illustrated in FIG. 8A

FIG. 9A is an illustration of alternative light source utilizing arc tube lamps as contemplated by embodiments of the present invention.

FIG. 9B is an illustration of alternative optic systems as contemplated by embodiments of the present invention.

FIG. 9C is an illustration of optic system with non-parallel beam paths as contemplated by embodiments of the present invention.

FIGS. 10A-B are charts of pulsed LED sources with increased luminous intensity as contemplated by embodiments of the present invention.

FIG. 11A is a diagram depicting polarized recycling utilizing multiple light sources of differing color and a light receiving environment as contemplated by embodiments of the present invention.

FIG. 11B is a diagram depicting polarized recycling utilizing multiple sources of the same wavelength combined with other combined sources of different wavelengths for use with (or as part of) a light receiving environment, as contemplated by embodiments of the present invention.

FIG. 11C is a diagram depicting use of transmissive LCDs in conjunction with (or as part of) a light receiving environment, as contemplated by embodiments of the present invention.

FIG. 11D is a diagram depicting use of more than one LCoS in conjunction with (or as part of) a light receiving environment, as contemplated by embodiments of the present invention.

FIG. 12A is a diagram depicting use of an LCoS projection environment in conjunction with (or as part of) various other embodiments (or aspects thereof) of the present invention.

FIG. 12B is a diagram of a transmissive LCD system as envisioned by embodiments of the present invention.

FIGS. 13A-13E are diagrams depicting light polarization recycling utilizing multiple light sources of differing color and dichroic plates, as contemplated by embodiments of the present invention.

FIGS. 14A-14E are alternate diagrams depicting light polarization recycling utilizing multiple light sources of differing color and dichroic plates, as contemplated by embodiments of the present invention.

FIGS. 15-16 are diagrams depicting aspects of color LCoS projection, as contemplated by embodiments of the present invention.

FIGS. 17A-17I are diagrams depicting light polarization recycling utilizing multiple light sources of differing color and dichroic plates, as contemplated by embodiments of the present invention.

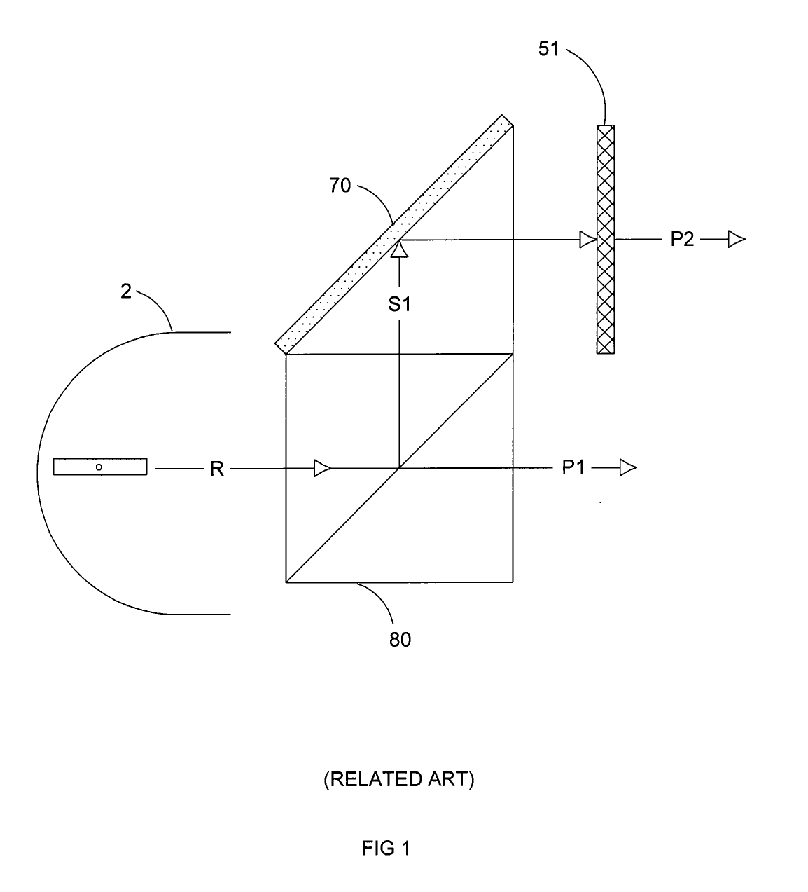

### IV. DETAILED DESCRIPTION

### A. Overview

For a better understanding of the invention, specific examples will now be described in greater detail. It should be understood that the invention is not limited by the specific embodiments or examples mentioned herein.

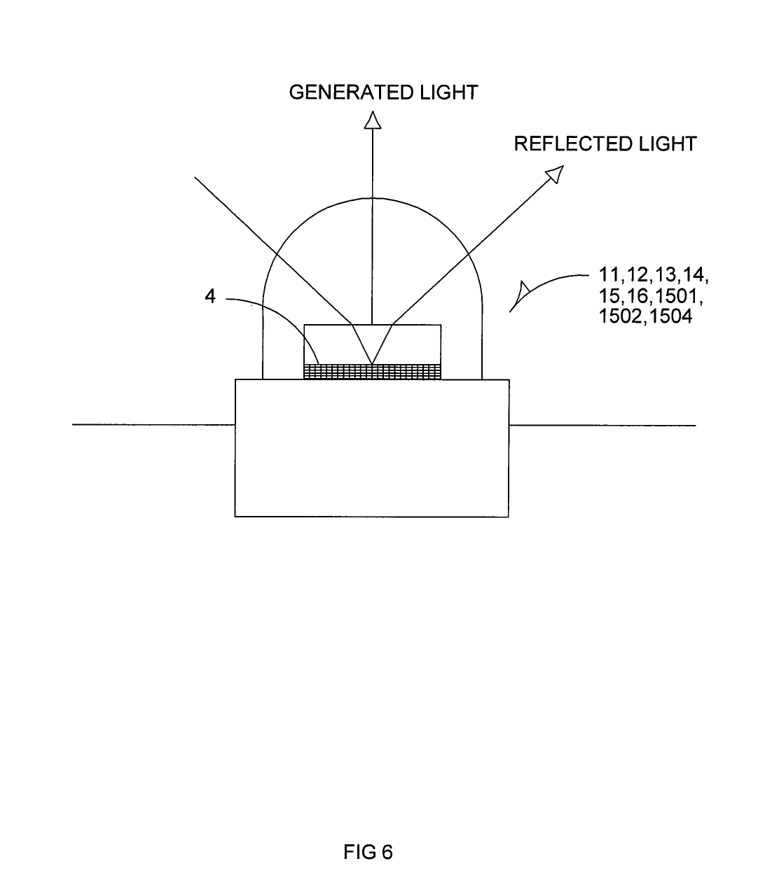

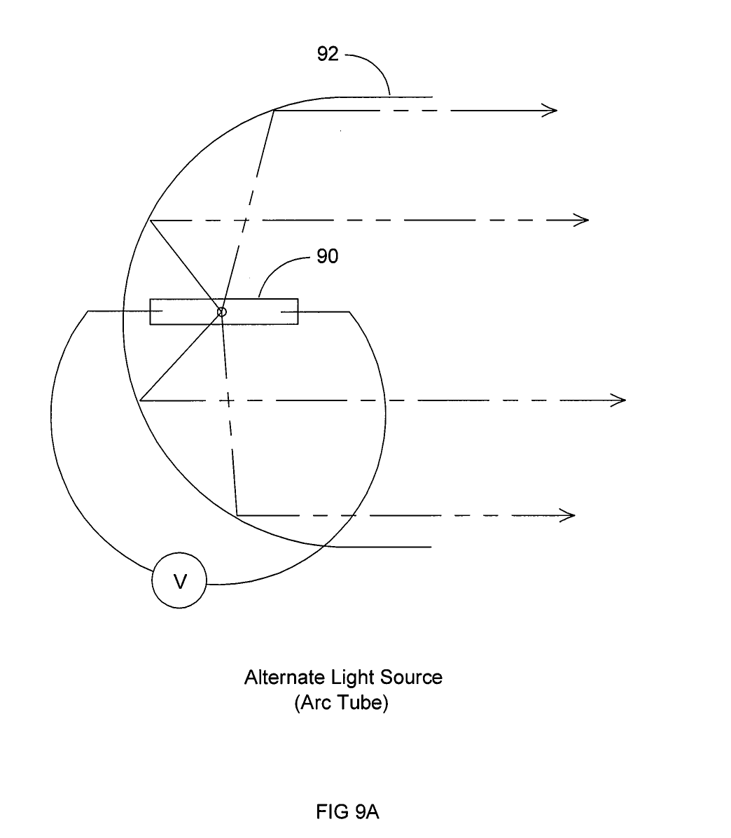

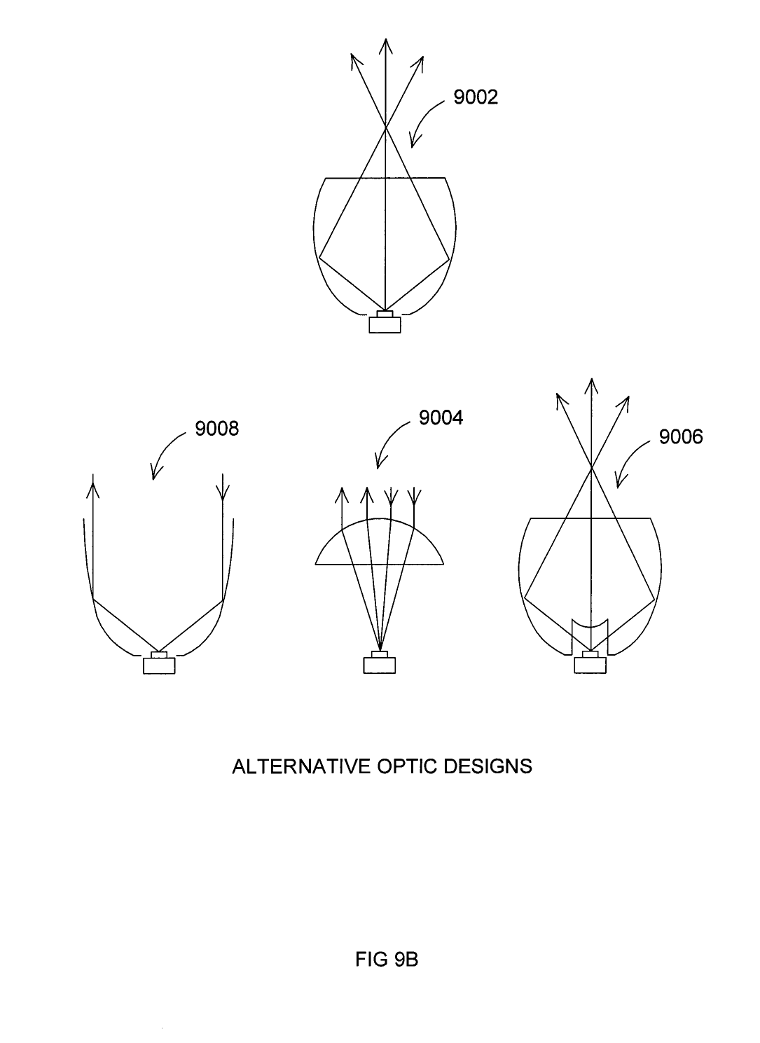

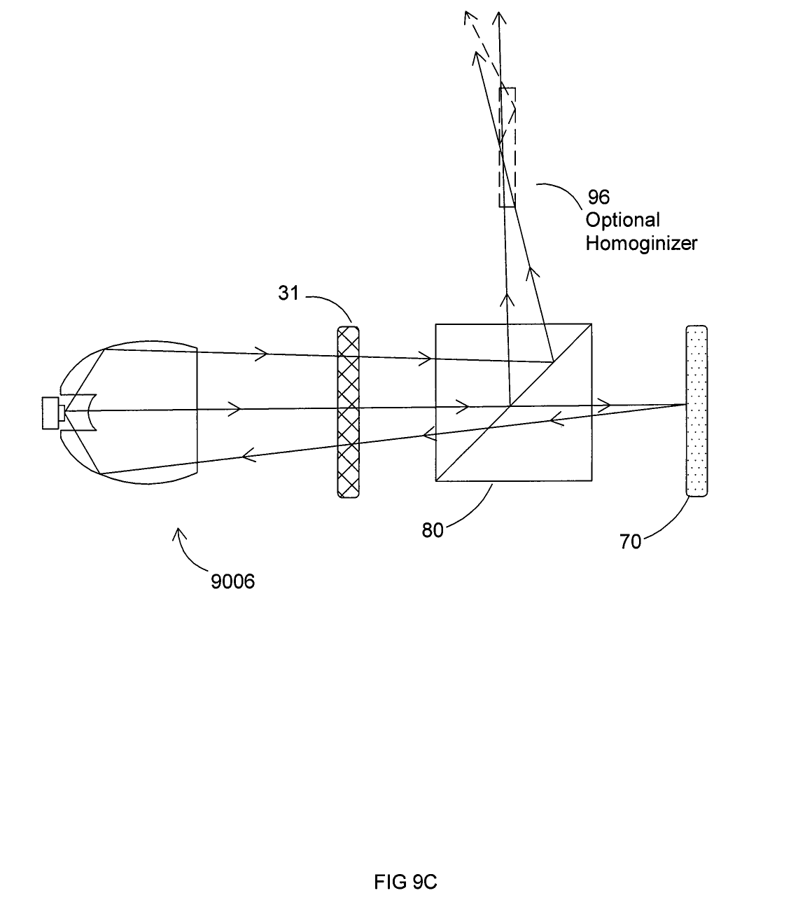

Some of the examples below will be described in the context of polarized light output used for projection, display screens, and similar applications. The light source contemplated for use in these examples is a high output LED light source with reflective substrate, such as those manufactured by Phillips Lumileds, model LXHL-PM01. A cross-section view of this type of LED is shown in FIG. 6. Other light sources with reflective properties or transmissive sources with surrounding reflective optics are considered suitable for use in this invention and can be used with various embodiments of the present invention. For example, an arc tube light source 90 with reflective housing 92 can be used, as is shown in FIG. 9A. Other applications beyond projection lighting and display screens may also be used with, or be part of, various embodiments of the present invention.

### B. Functionality of Typical System Components

The following is a brief description of components that may be used and their function in recycling light in accordance with the various embodiments of the present invention. These functions are generally understood by technical people in the field of optics.

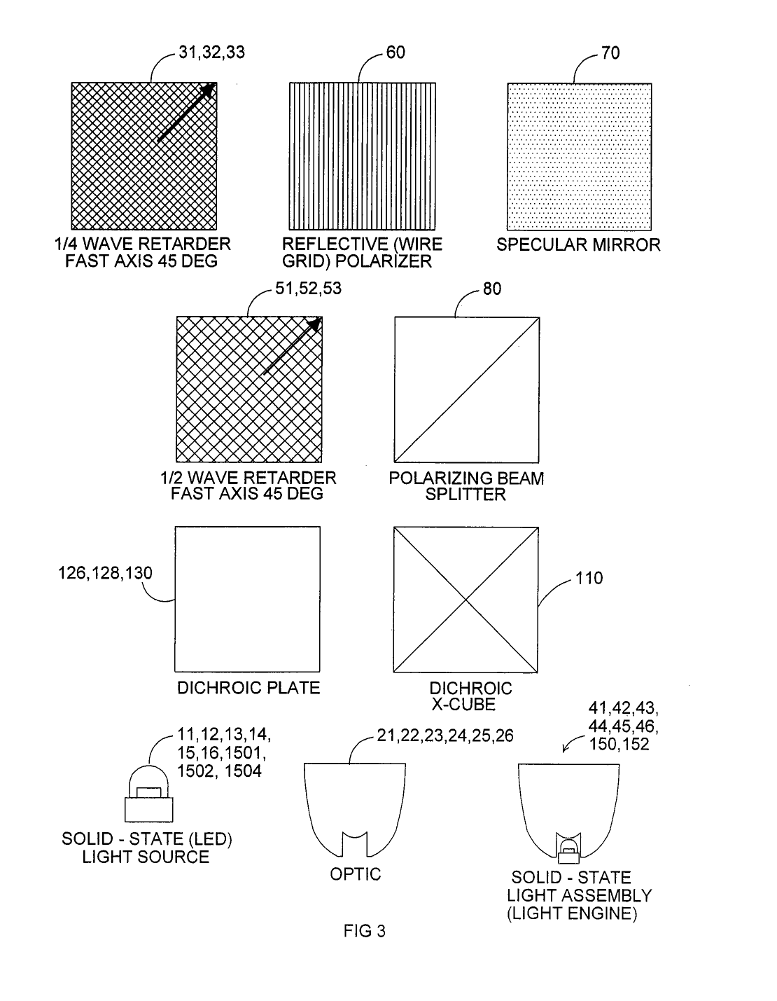

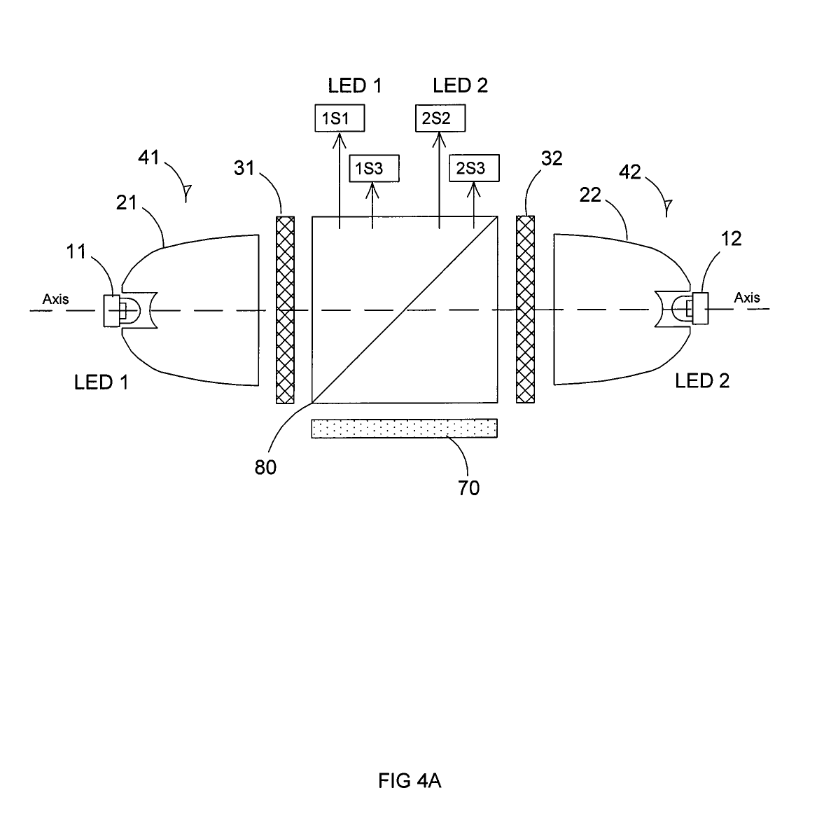

The recycling of polarized light as contemplated by embodiments of the present invention can be accomplished by use of optical components such as wave retarders, polarizing beam splitters, reflective polarizers, mirrors and light sources with reflective substrates and optic assemblies. A legend of the symbols used in some of the figures of the present application is shown in FIG. 3. The reference numerals designating the various components in FIG. 3 also generally designate components in the other figures of this application. A general description of these components, as contemplated by one or more embodiments of the present invention, is as follows:
1) ¼ wave retarder (or waveplate) with the fast axis rotated 45 degrees to the plane of polarization (items 31,32,33)—this is a type of waveplate that phase shifts the polarization of the light by one-quarter of a wave, i.e. 90 degrees. Two passes of the light are required to fully convert one state of polarization to the opposite state of polarization. For example, linear polarized light S is converted to Sc on the first pass. The “c” represents the change to circular polarization. Upon the second pass, the circular Sc is converted to the opposite linear polarization P.
2) ½ wave retarder with the fast axis rotated 45 degrees to the plane of polarization (items 51,52,53)—this is also a type of waveplate that converts polarized light. It converts the light from one state of polarization to the opposite state of polarization in a single pass. This is because the phase shift is equal to one-half of a wave, or 180 degrees. For example, linear polarized light S is converted to linear polarized light output P.
3) Polarizing Beam Splitter (PBS) (item 80)—this is a component that reflects one state of polarization and allows the opposite state of polarization to pass through. The reflected light is generally reflected perpendicular to the source. PBS components can be configured to reflect either P or S polarization.
4) Reflective polarizer (item 60)—this component will pass one state of polarized light and reflect the opposite state of polarized light. It can be configured to reflect either polarization while allowing its opposite to pass through.
5) Mirror (item 70)—this component reflects the light without any polarization selection or conversion. The state of the input light will be the same as the state of the output.
6) Light source with reflective substrate and optics (referred to as light engine 41-46, 150, 152 which collectively includes items 11-16, 21-26, 1501 and 1502)—this component generates the light and also provides reflection of received light. LED light source (11-16, 1501 and 1502) with reflective substrate is just one example of a “light source” that can be used. Other solid state light sources are also contemplated, as is an arc tube light source with reflective optics. FIG. 6 illustrates how light is reflected off the reflective substrate 4 of the LED light source 11-16, 1501 and 1502.
7) Dichroic Plate (126, 128, 130)—a material that separates light into beams of different wavelengths. A common use is a thin film coating used as an interference filter that reflects and transmits wavelengths in certain ranges.
8) Dichroic cross prism (x-cube) (item 110)—optical component typically constructed of four right angle prism pieces with dichroic coating to reflect a given wavelength and transmit others. It is commonly used to combine light of different wavelengths. One source for such x-cube devices is Nitto Optical Co., LTD. of Tokyo, Japan.

### C. General Method and System of Example Embodiments

In general, polarized light recycling methods and systems contemplated herein envision utilizing one or more light engines each having a single LED light source with an optic assembly. These light engines are generally designed to project the light output parallel to the axis of the optic assembly, and can be used as an integral part of various light-related applications. As an example of general operation using ¼ wave retarders, the randomly polarized light R exits a light engine and passes through a ¼ wave retarder in optical communication with the light engine, where the ¼ wave retarder is positioned substantially in front of the opening of the optic assembly. (“Optical communication” meaning that light from one item or position can reach another item or position.) The randomly polarized light R is phase shifted by the wave retarder, but remains randomly polarized. The light then travels to a polarized beam splitter (PBS), which splits the light R into S and P polarized components. S polarized light is directed to a light receiving environment, while the remaining P polarized light transmits through PBS to a reflective mirror, which reflects the light back through the PBS and through a wave retarder. The second pass of the P light through a wave retarder converts the light from linear P into circular Pc polarization. The Pc light is directed to a light engine and is reflected back out off the reflective substrate (FIG. 6) of the LED (as well as, to possibly some degree, the optic of the light engine). Pc light is reflected out of the light engine and back through a wave retarder which converts the circular polarized light Pc into linear polarized light S′. S′ is then also directed to a light receiving environment. The total polarized light output is thus S and S′.

The methods and systems envisioned herein can produce polarized light output of a given orientation (e.g., S component) that is substantially greater than the initial output of the light source at that orientation, with the same amount of energy consumed. In addition, the output area, and thus the etendue, is conserved.

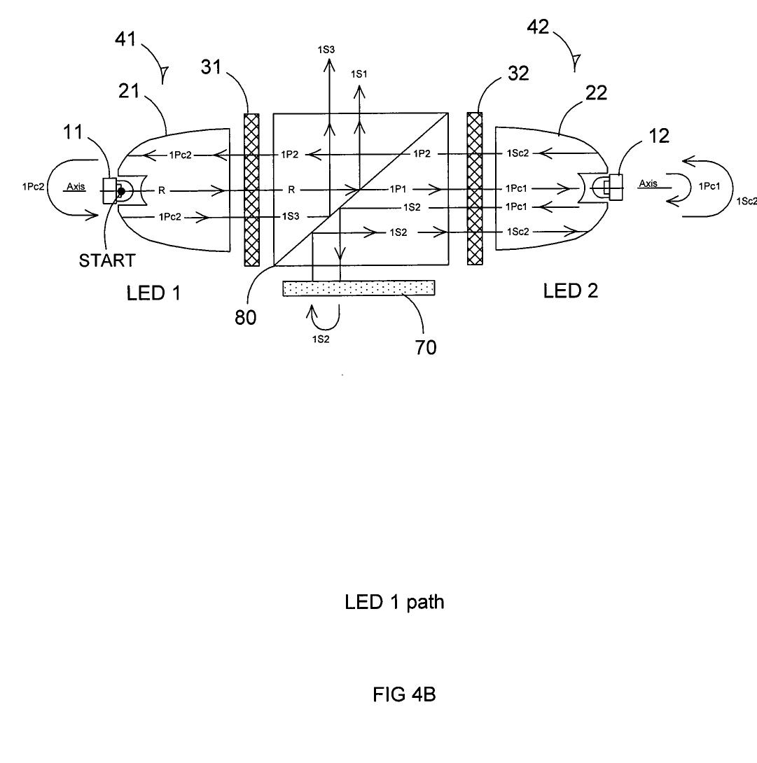

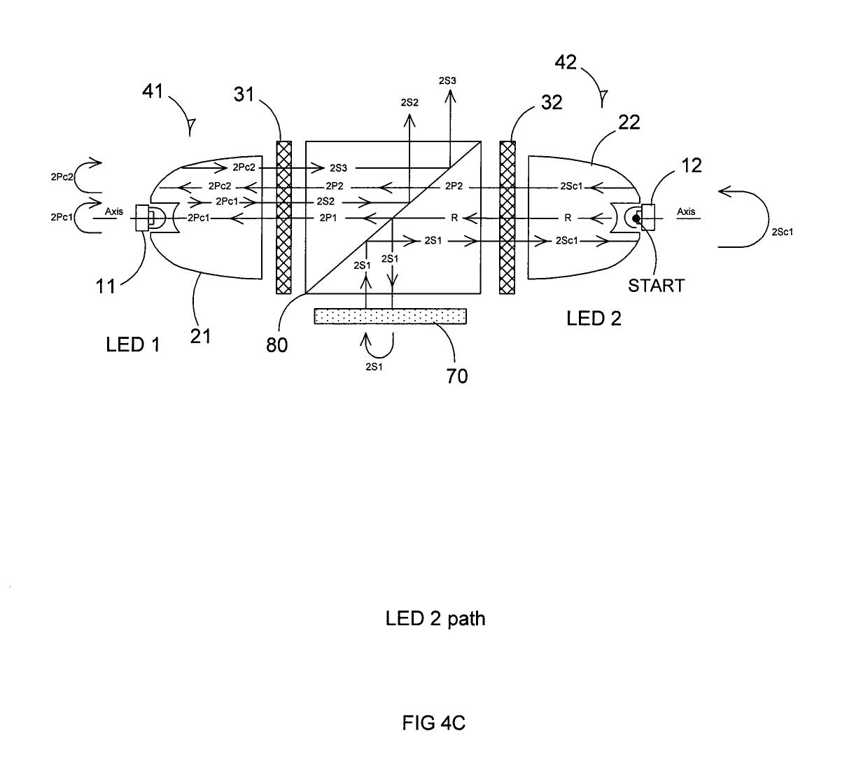

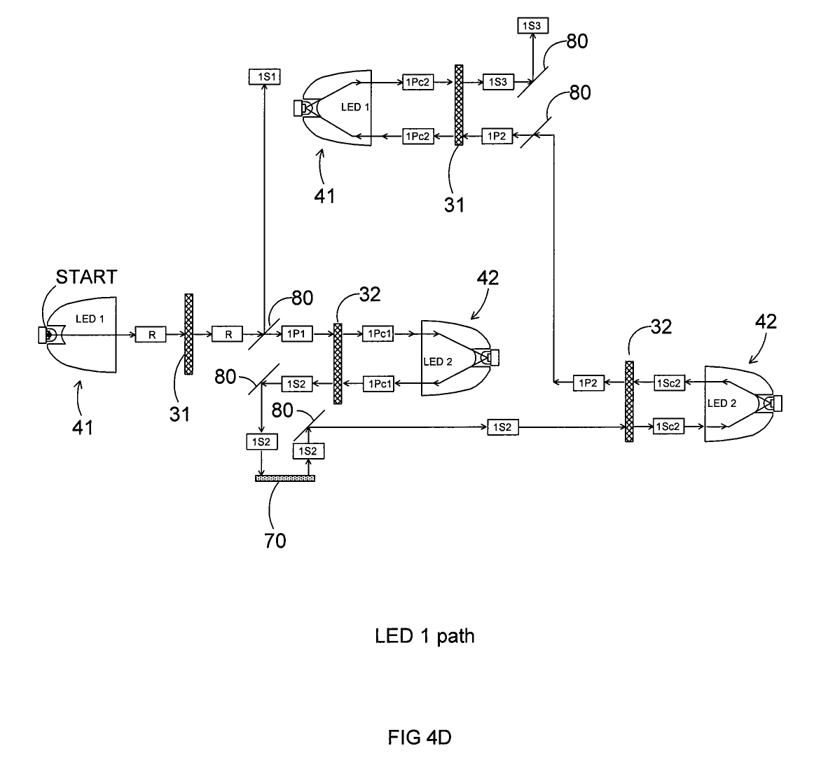

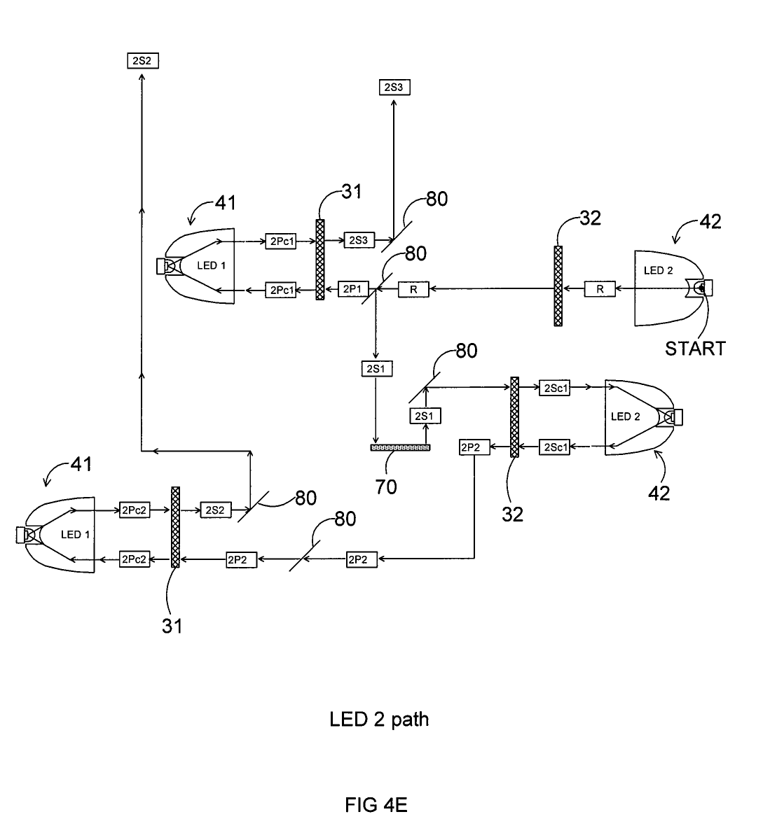

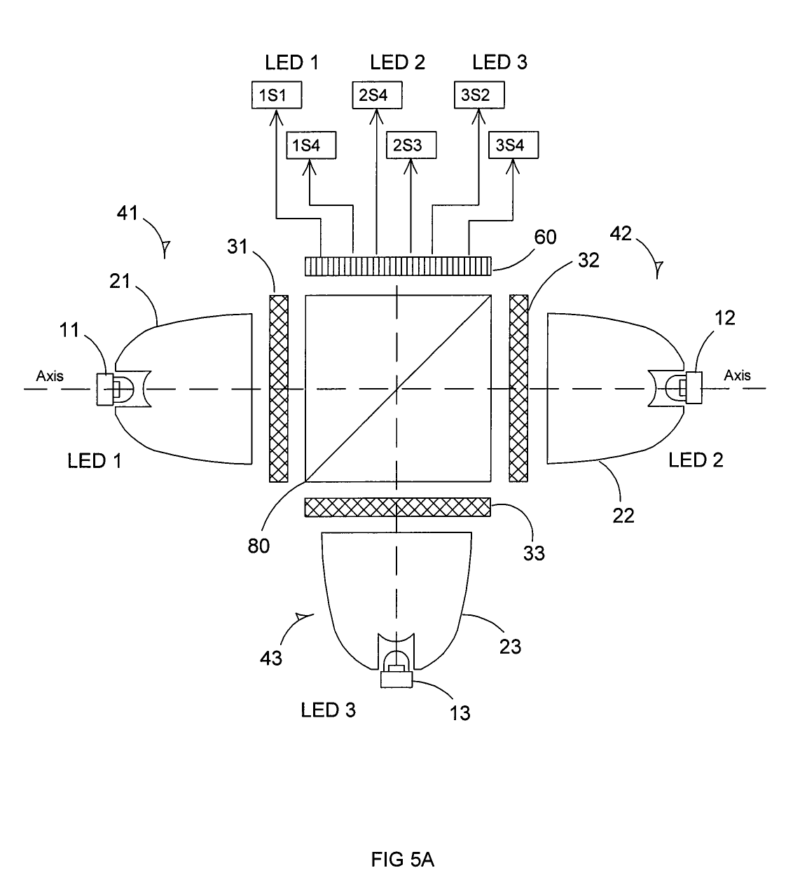

### D. Method and System of Exemplary Embodiments of FIGS. 4A-4E

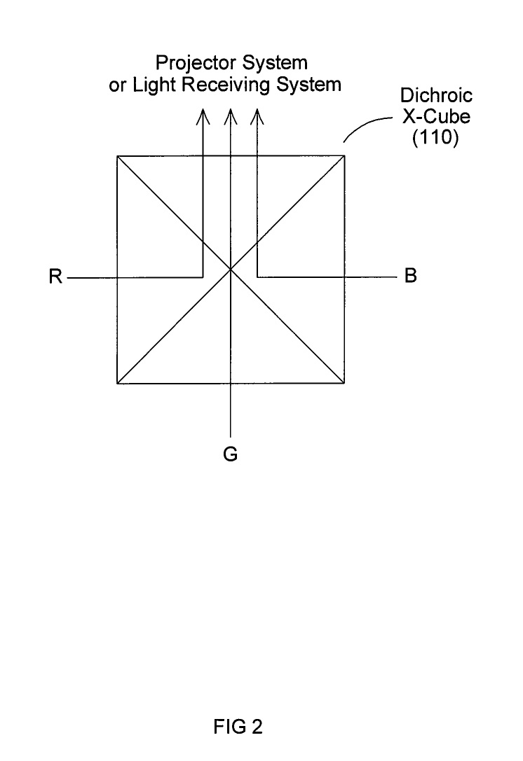

FIG. 4A illustrates in diagram form a polarized light recycling method and apparatus utilizing two light engines 41 & 42. Light engine 41 is comprised of LED light source 11 with optic assembly 21 and light engine 42 is comprised of LED light source 12 with optic assembly 22, both designed to project the light output parallel to the axis of the optic assembly. The two light engines 41 and 42 are positioned opposite each other so that their optic axes substantially align, as shown (e.g., the center of the opening of optic assembly 21 is substantially aligned with the center of the opening of optic assembly 22) and such that light may be directed back and forth. ¼ wave retarder 31 is positioned in front of optic assembly 21 and ¼ wave retarder 32 is positioned in front of optic assembly 22. PBS 80 is located between the two ¼ wave retarders 31 and 32. Positioned 90 degrees from the axes of optic assemblies 21 & 22, and directly below the PBS 80 is reflective mirror 70 to reflect the light back to the PBS and to optic assembly 22. Four polarized light outputs (i.e., 1S1, 1S3, 2S2, 2S3) are reflected off the PBS at 90 degrees off the optic axis. These four polarized light outputs, which represent the total polarized light output of the system, are parallel to each other and perpendicular to the original light axis. The path of light and the conversion from one state of polarization to the opposite state can be traced in FIG. 4B for light engine 41 and FIG. 4C for light engine 42. Likewise, a flow diagram of the light path is also depicted in FIGS. 4D and 4E. Although, for purposes of drawing clarity, light paths such as 1Pc2 and 15c2 in FIGS. 4B and 2Pc2 and 2Sc1 in FIG. 4C were not drawn as being in contact with LED 11 and LED 12, respectively, it should be understood that various embodiments contemplated by FIGS. 4A-4E do contemplate that the LED light sources are substantially the source of the reflection of those light paths. A similar situation exists and should be evident in various other examples below.

In a lossless optical system, the embodiments described above may produce a polarized light output that is approaching nearly four times the polarized light output of a conventional LED and linear polarizer combination, with double the amount of energy consumed. In addition the output area and etendue is substantially conserved, resulting in a substantial gain in luminance from the source output aperture.

Although the parallel light paths are shown to be at a distance from one another in the figures, it should be understood that embodiments of the present invention contemplate that they can be, and typically are, additively combined or at least in substantial proximity to one another. A similar situation exists and should be evident in various other examples below.

Various embodiments envisioned by FIGS. 4A-4E (as well as other example embodiments described below) can be constructed of typical components used in optical assemblies and supplied by any number of supply sources. At least some of these components can be supplied by Edmund Optics of Barrington, N.J., USA. For improved efficiency, one or more embodiments of the present invention as envisioned herein contemplate that the optic assembly can be designed to be highly optimized in redirecting light to exit parallel to the axis of the optic assembly. For reduced component count, various devices can be combined using thin film coating techniques to provide the same functionality as discrete components. As an example, in various embodiments shown above, the mirror 70 could be replaced by a vacuum metallized coating on the appropriate side of the PBS 80.

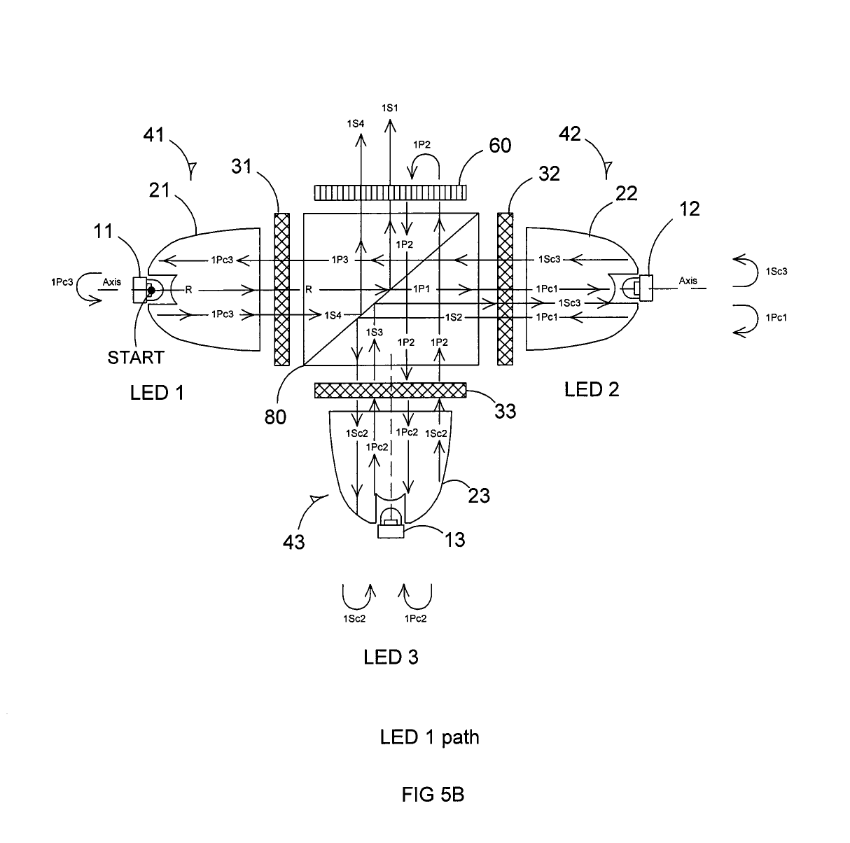

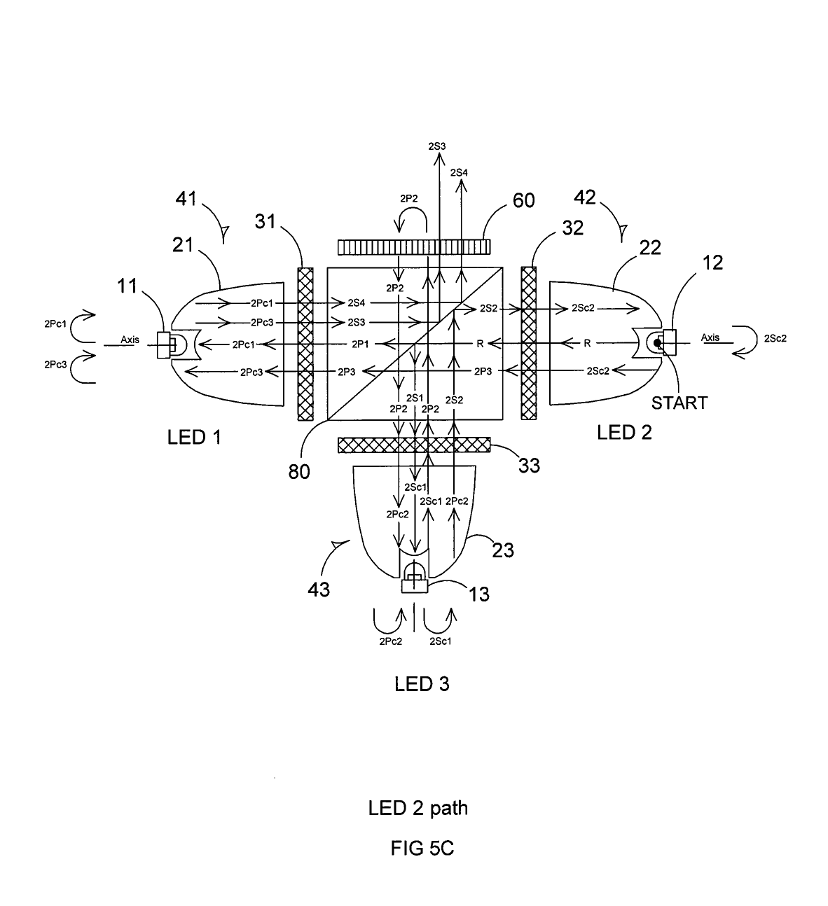

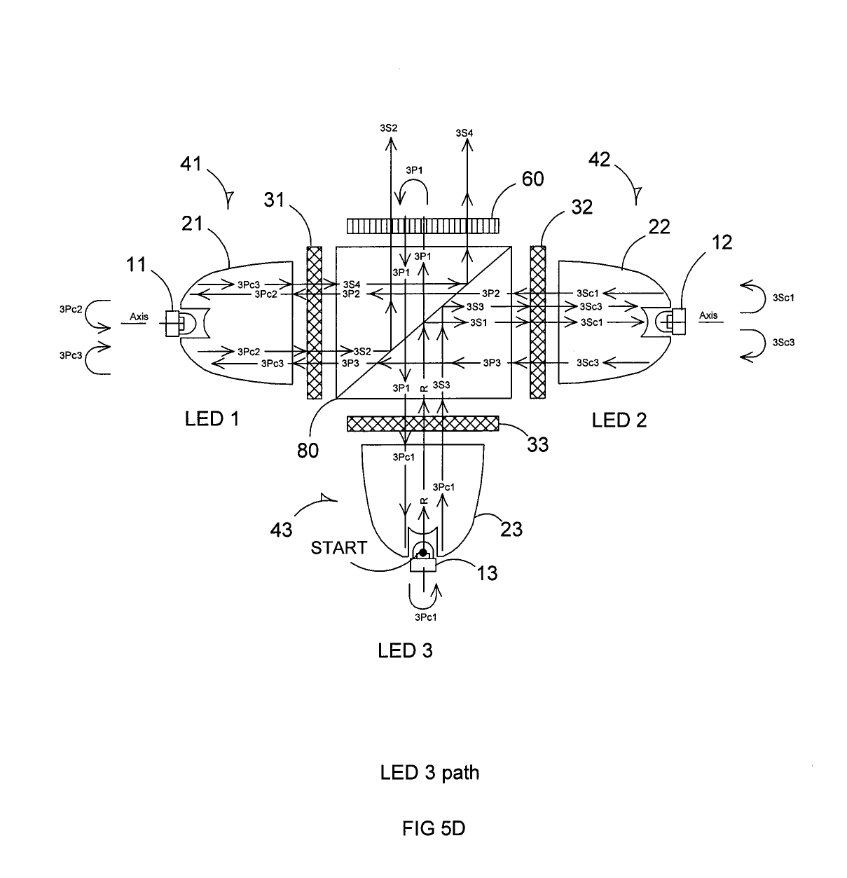

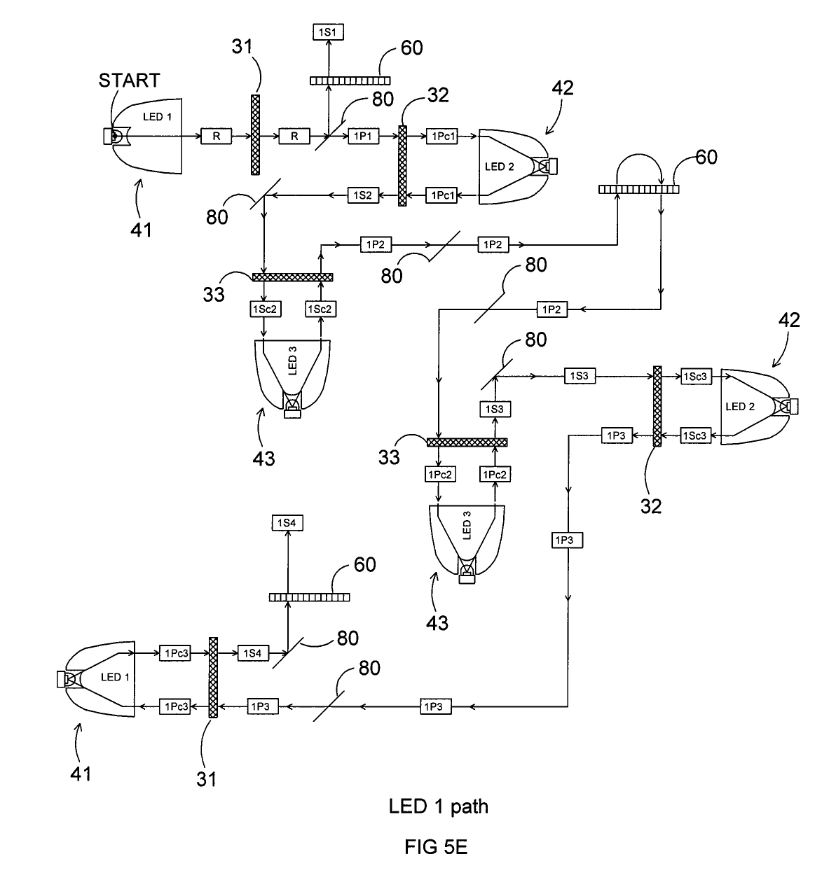

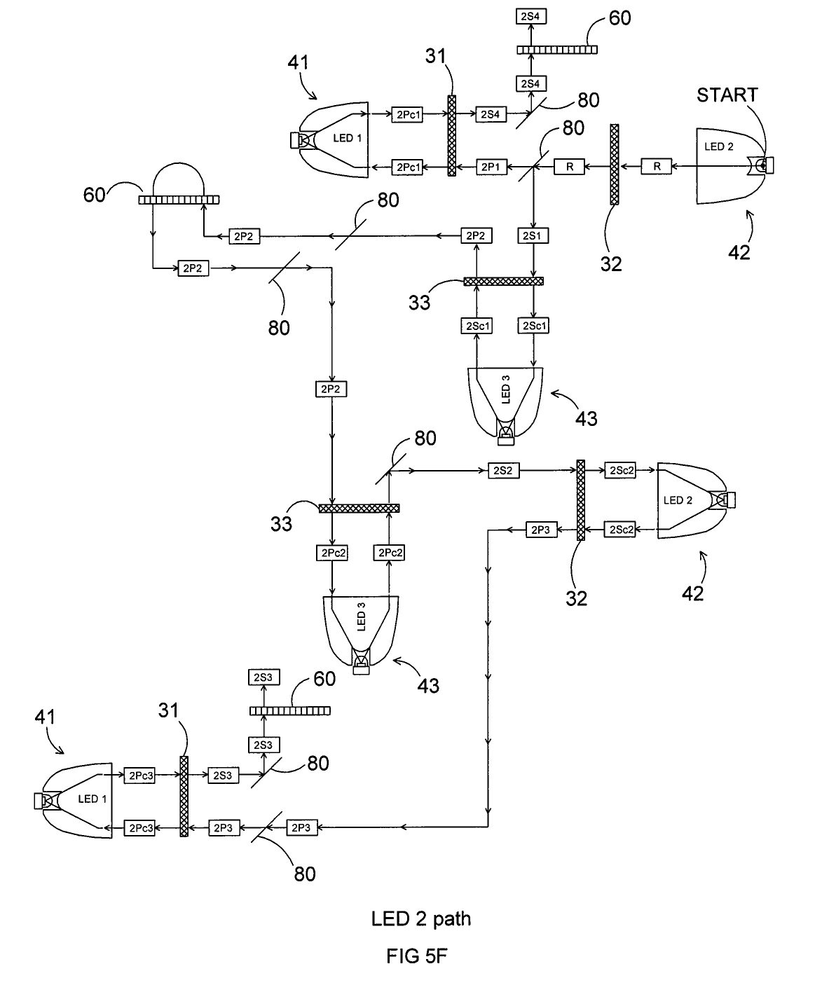

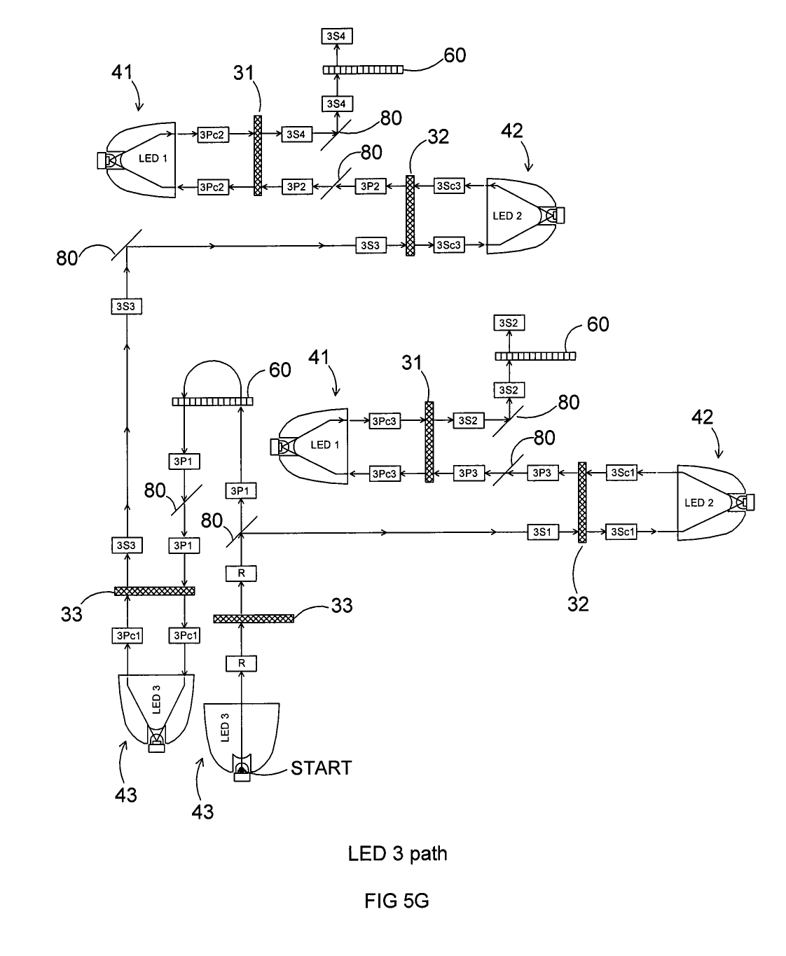

### E. Method and System of Exemplary Embodiments of FIGS. 5A-5G

FIG. 5A illustrates in diagram form a polarized light recycling method and system utilizing three light engines 41,42 & 43. Light engine 41 is comprised of LED light source 11 with optic assembly 21, light engine 42 is comprised of LED light source 12 with optic assembly 22, and light engine 43 is comprised of LED light source 13 with optic assembly 23. All three are designed to project the light output parallel to the axis of their respective optic assemblies. Two of the three light engines 41 and 42 are positioned opposite each other so that light may be directed back and forth. The third light engine 43 is located 90 degrees from the opposing two light engines 41 & 42. ¼ wave retarder 31 is positioned in front of optic assembly 21, ¼ wave retarder 32 is positioned in front of optic assembly 22 and ¼ wave retarder 33 is positioned in front of optic assembly 23. PBS 80 is located between the three ¼ wave retarders 31-33 as shown. On the opposite side of the PBS 80 from light engine 43 is reflective polarizer 60. Light is reflected back and forth between the three LED sources until it exits the reflective polarizer 60 in the designated polarization (which in this example is S). Since light engine 43 is positioned 90 degrees from the optic axis of the other LED sources, reflective polarizer 60 will reflect back the P polarized light from light engine 43 for conversion into S. Similar to various embodiments mentioned above, the light output S (i.e., those outputs that passed through reflective polarizer 60) is reflected off the PBS at 90 degrees off the optic axis of light engine 41 and light engine 42. The six polarized light outputs from light engine 41, light engine 42, and light engine 43 are parallel to each other and perpendicular to the original light axis formed by light engine 41 and light engine 42. The total polarized light output is shown as 1S1, 1S4, 2S3, 2S4, 3S2 and 3S4. The path of light and the conversion from one state of polarization to the opposite state can be traced in FIG. 5B for light engine 41, FIG. 5C for light engine 42 and FIG. 5D for light engine 43. Likewise, flow diagrams of the light path are also depicted in FIG. 5E-5G.

In a lossless optical system, the embodiments described above may produce a polarized light output that is approaching nearly six times the polarized light output of a conventional LED and linear polarizer combination, with three times the amount of energy consumed. In addition the output area and etendue is substantially conserved resulting in a significant gain in luminance from the source output aperture.

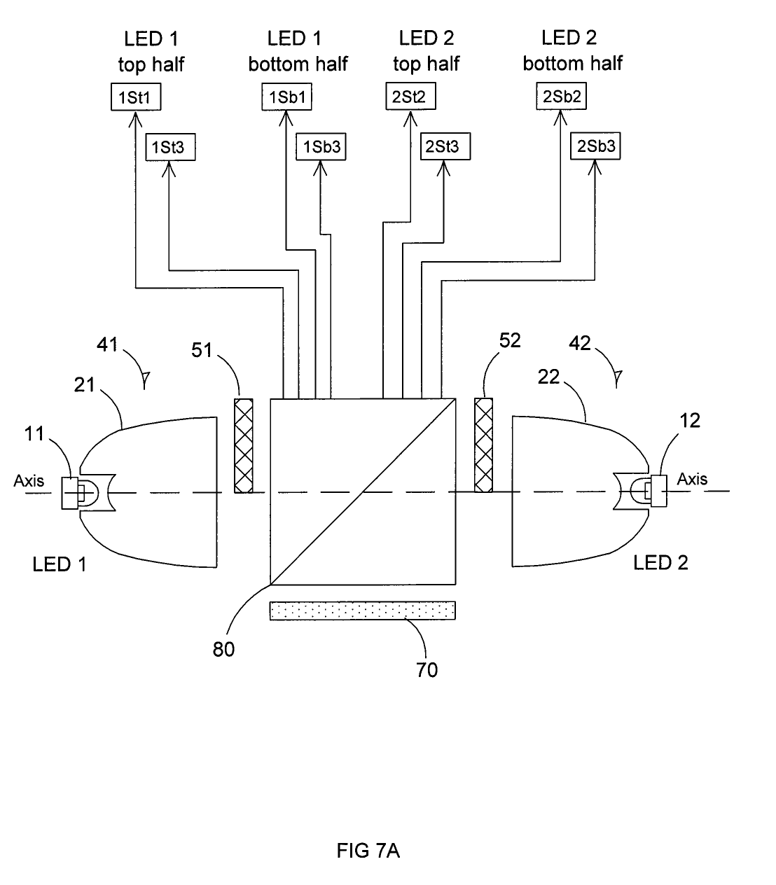

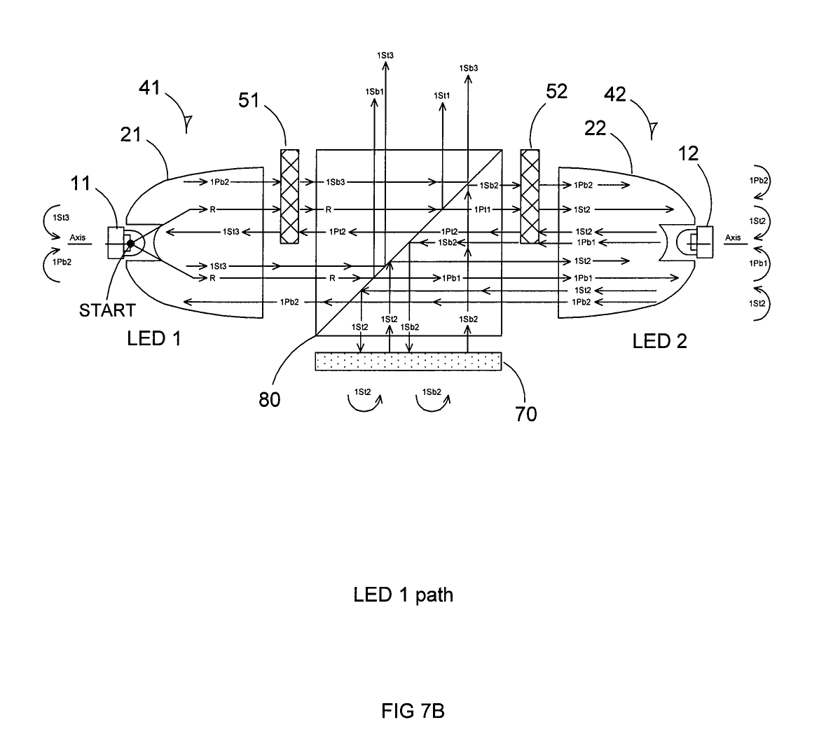

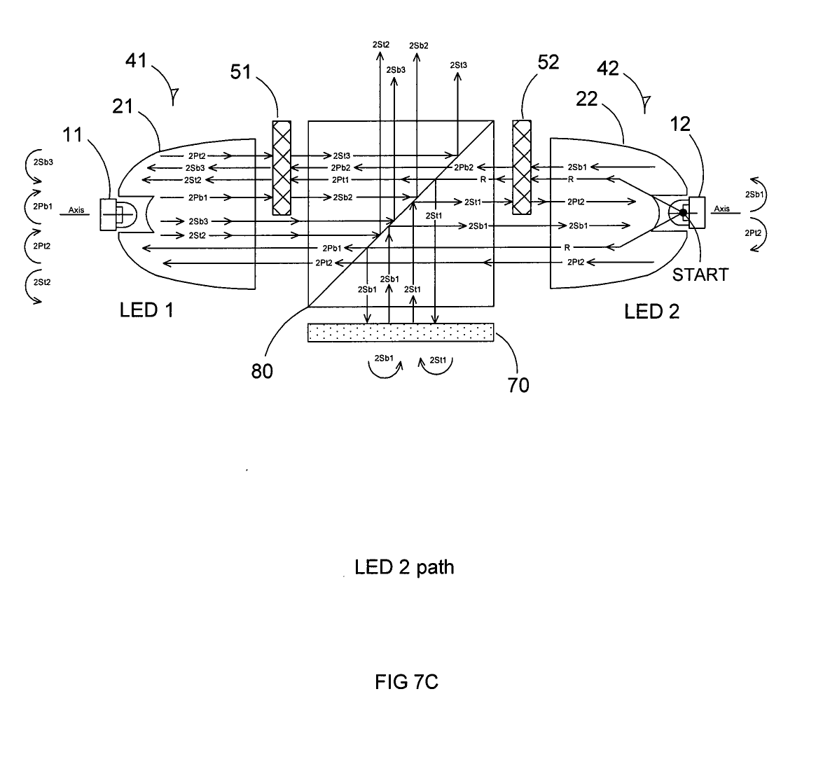

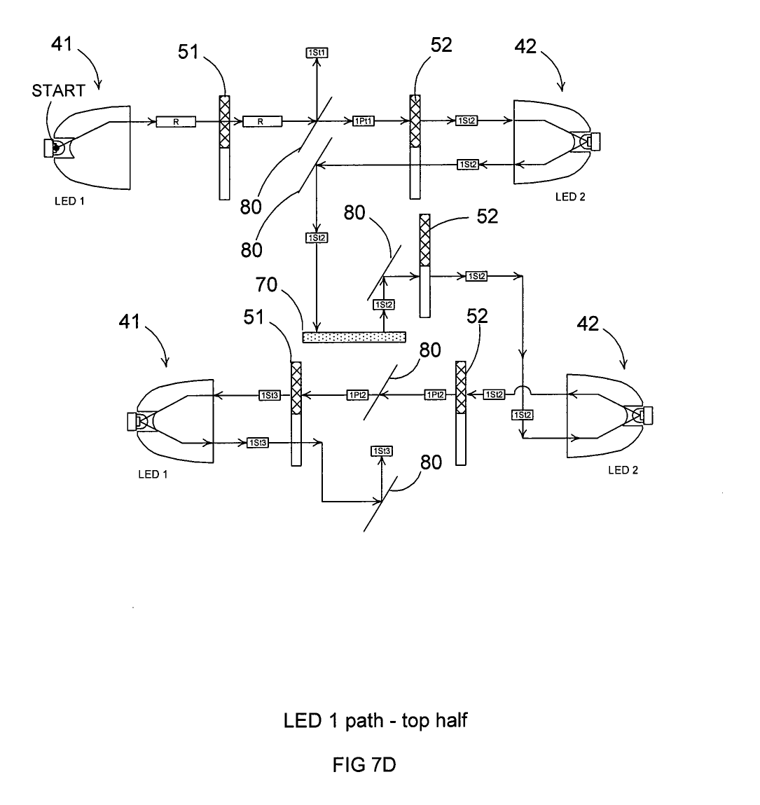

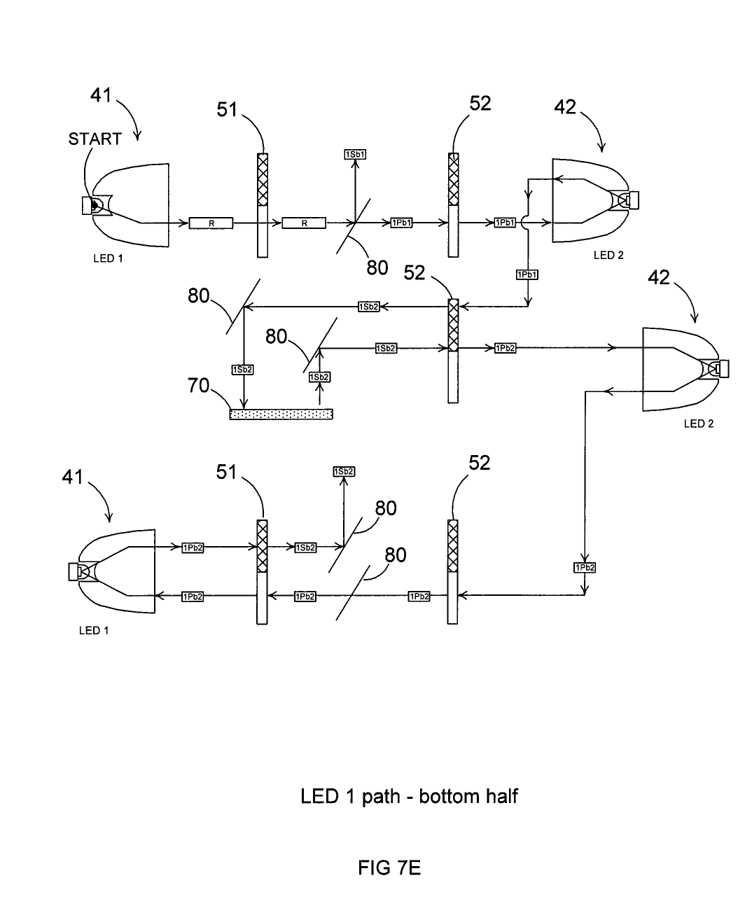

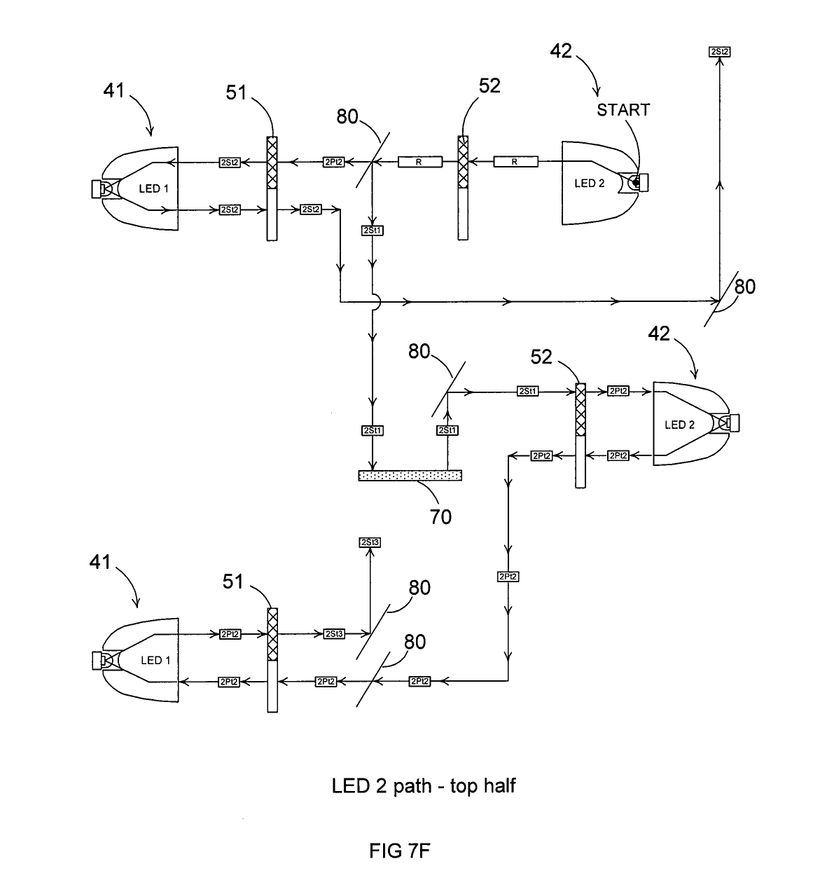

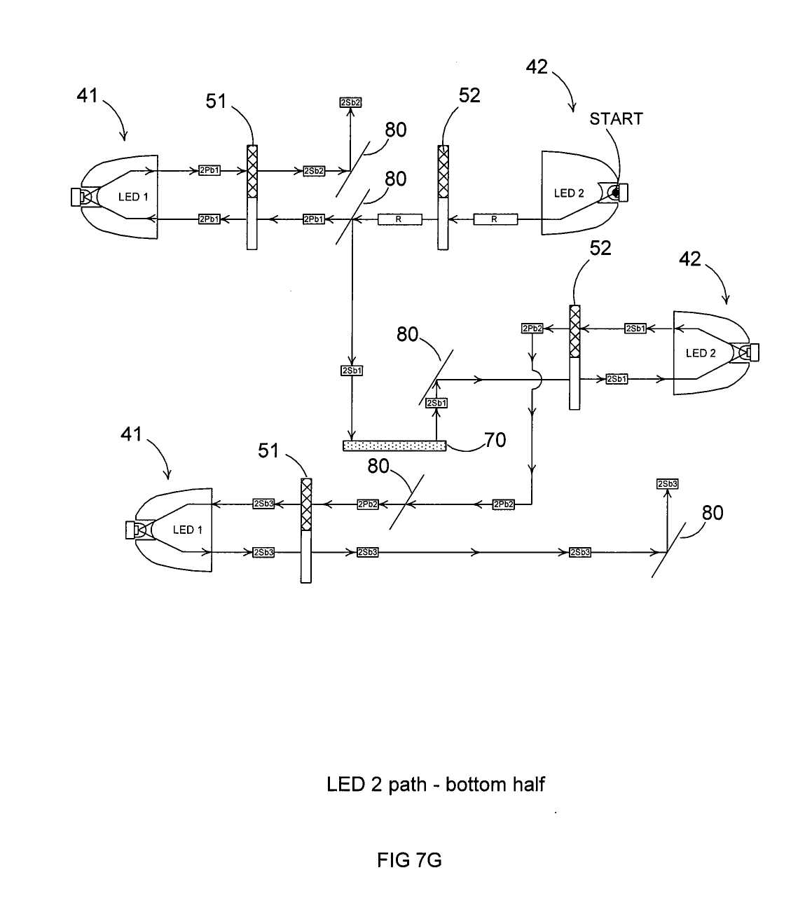

### G. Method and System of Exemplary Embodiments of FIGS. 7A-7G

FIG. 7A illustrates in diagram form a polarized light recycling method and system utilizing two light engines 41 and 42 and ½ wave retarders. Light engine 41 is comprised of LED light source 11 with optic assembly 21 and light engine 42 is comprised of LED light source 12 with optic assembly 22, both designed to project the light output parallel to the axis of the optic assembly. The two light engines 41 and 42 are positioned opposite each other so that light may be directed back and forth. ½ wave retarder 51 is positioned in front of a top portion of optic assembly 21 and ½ wave retarder 52 is positioned in front of the top portion of optic assembly 22 (as shown), such that the location of each ½ wave retarder substantially covers one of the half planes created by a line perpendicular to the optic axis (generally the half planes need to have inverse coverage of waveplates). PBS 80 is located between the two ½ wave retarders 51 and 52. Positioned 90 degrees from the axis of optic assemblies 21 and 22, and directly below the PBS 80 (as shown) is reflective mirror 70 to reflect the light back to the PBS and to optic assembly 22. In one or more embodiments envisioned by FIGS. 7A-7G, the light emanating from each LED source (11, 12) takes one of two initial parallel paths. In one of the paths, the light initially passes through one of the ½ wave retarders (51 or 52), and in the other path, it does not. In effect, this basically creates a top path (designated by “t” in the light path labels) and bottom path (designated by “b” in the light path labels). Light that passes through the ½ wave retarder is converted into the opposite state of polarization in a single pass while light that passes through the lower portion of the optics (i.e., not through the ½ wave retarder) is not converted and retains its original state of polarization. Thus, each LED light source (11, 12) creates four light paths (Pt, St, Pb, Sb). Similar to one or more embodiment of the present invention mentioned above, the light output S is reflected off the PBS at 90 degrees off the optic axis. The eight polarized light outputs from light engine 41 and light engine 42 are parallel to each other and perpendicular to the original light axis. The total polarized light output is shown as 1St1, 1St3, 1Sb1, 1Sb3, 2St2, 2St3, 2Sb2, and 2Sb3. The path of light and the conversion from one state of polarization to the opposite state can be traced in FIG. 7B for light engine 41 and FIG. 7C for light engine 42. Likewise, a flow diagram of the light path is also depicted in FIGS. 7D-7G.

In a lossless optical system, the embodiments described above may produce a polarized light output that is approaching nearly four times the polarized light output of a conventional LED and linear polarizer combination, with double the amount of energy consumed. In addition the output area and etendue is substantially conserved resulting in a significant gain in luminance from the source output aperture. Also, one or more embodiments of the present invention contemplate the location of the ½ wave retarder to substantially cover one of the half planes created by a line perpendicular to the optic axis.

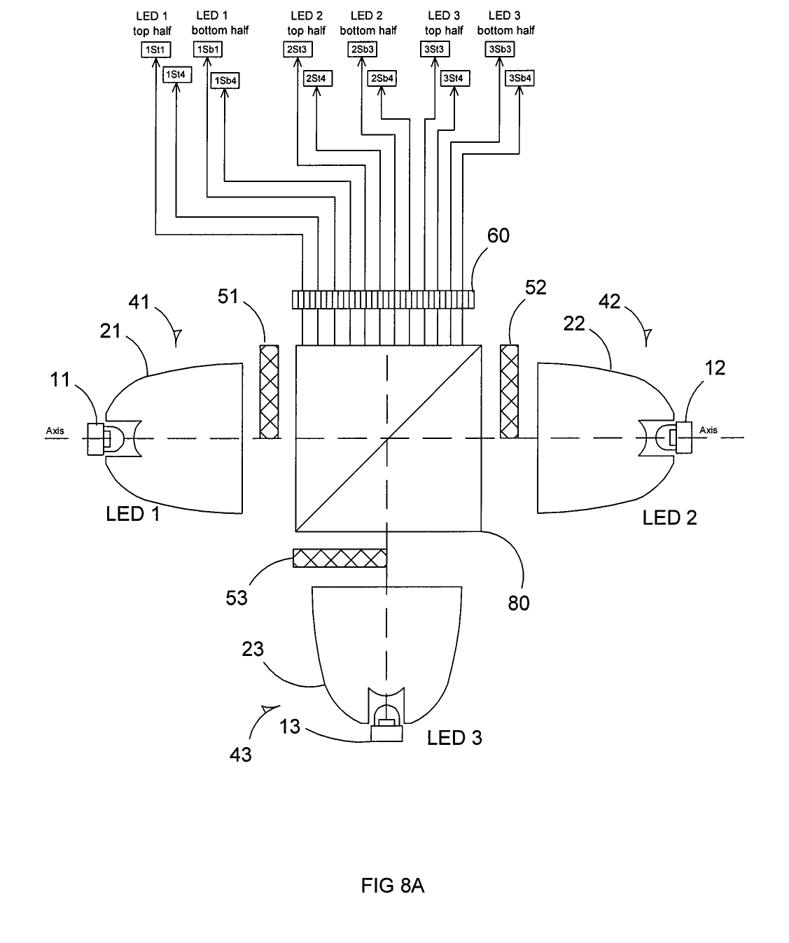

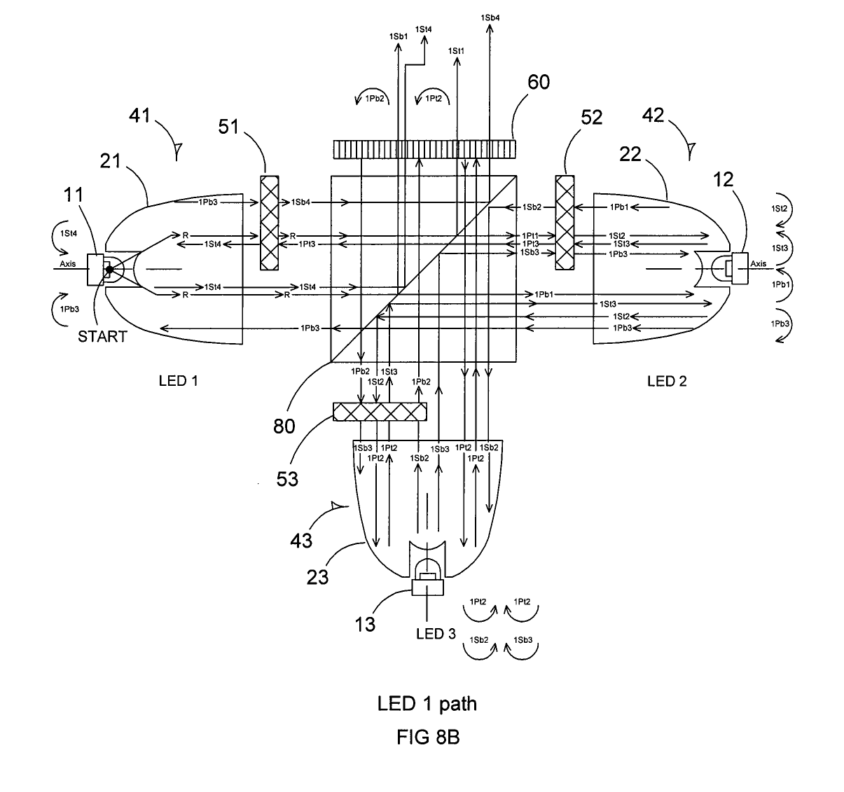

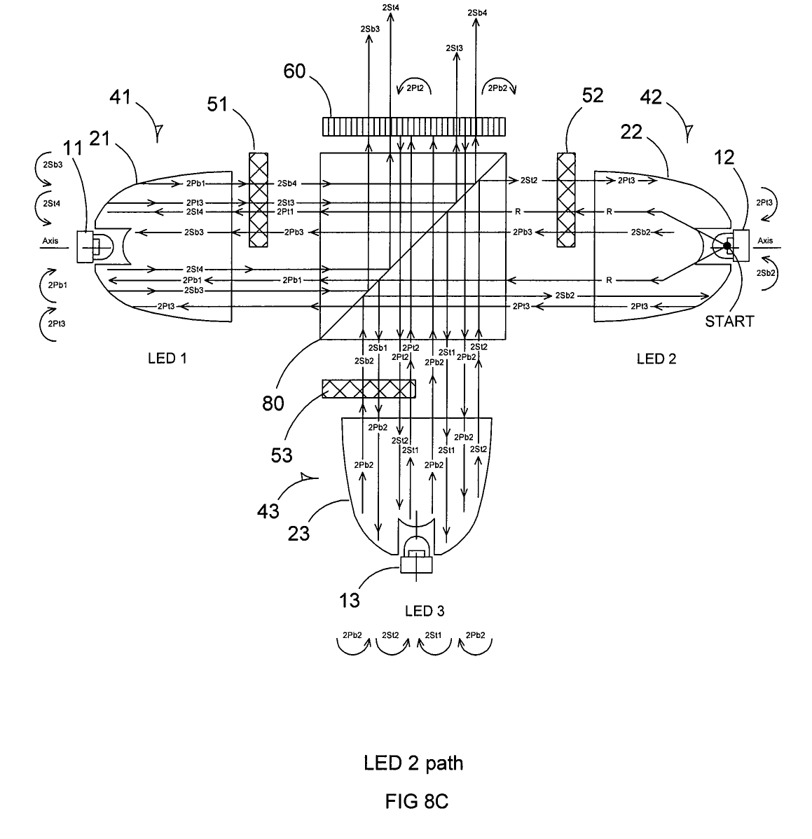

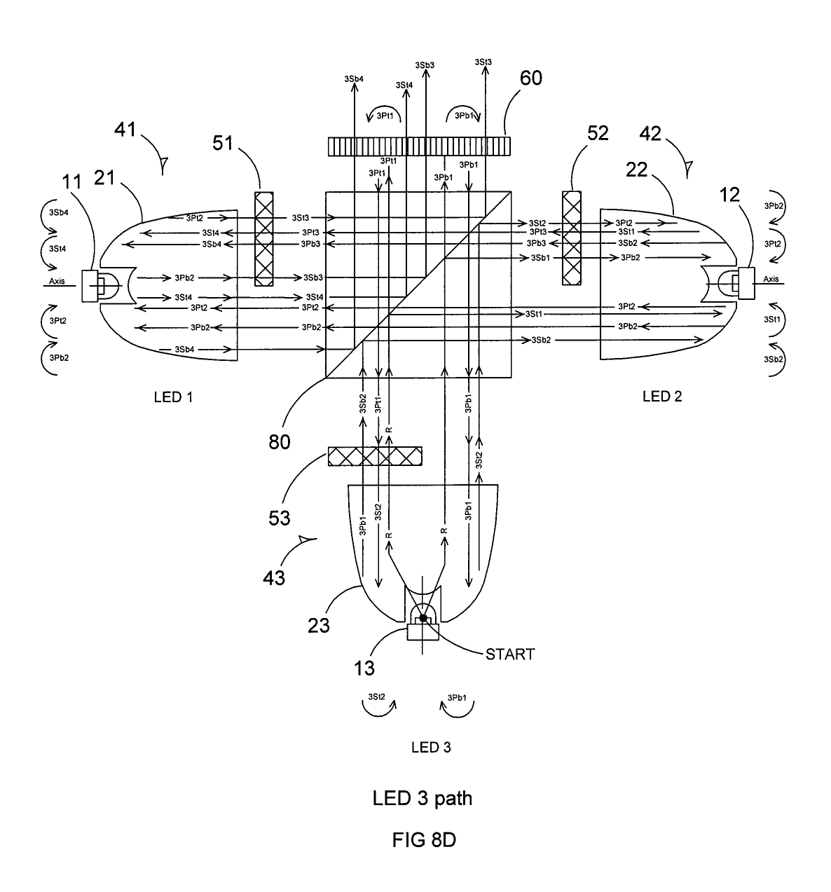

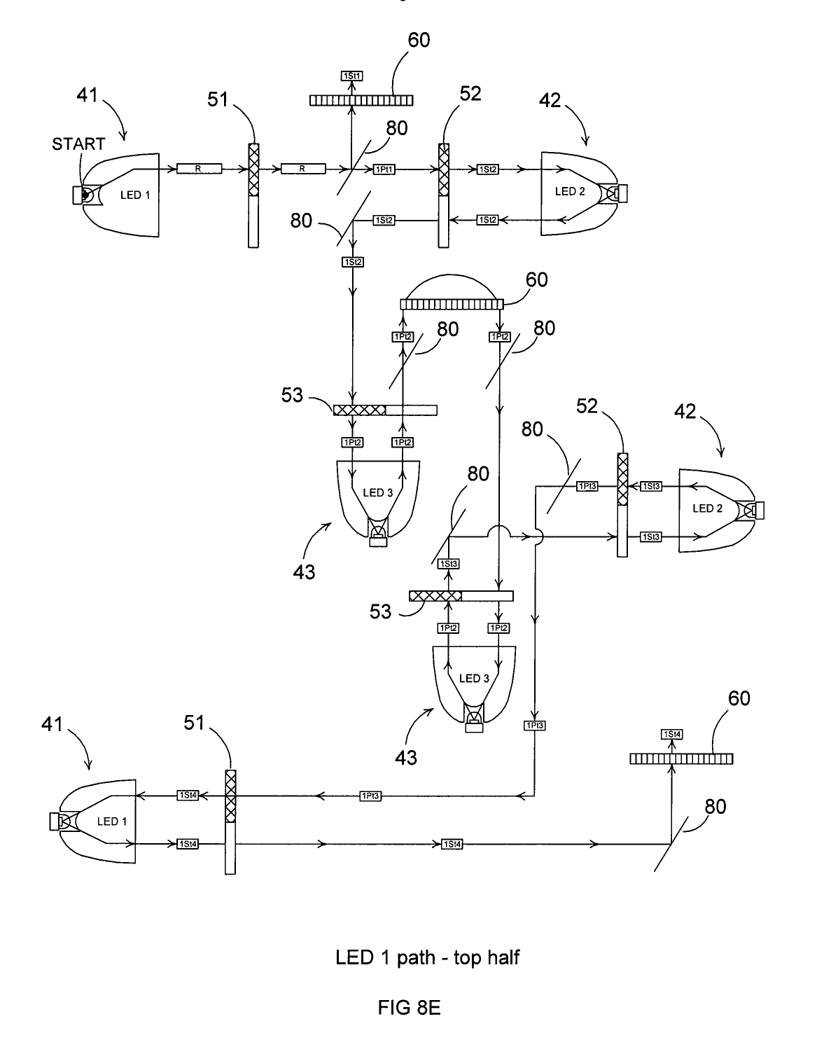

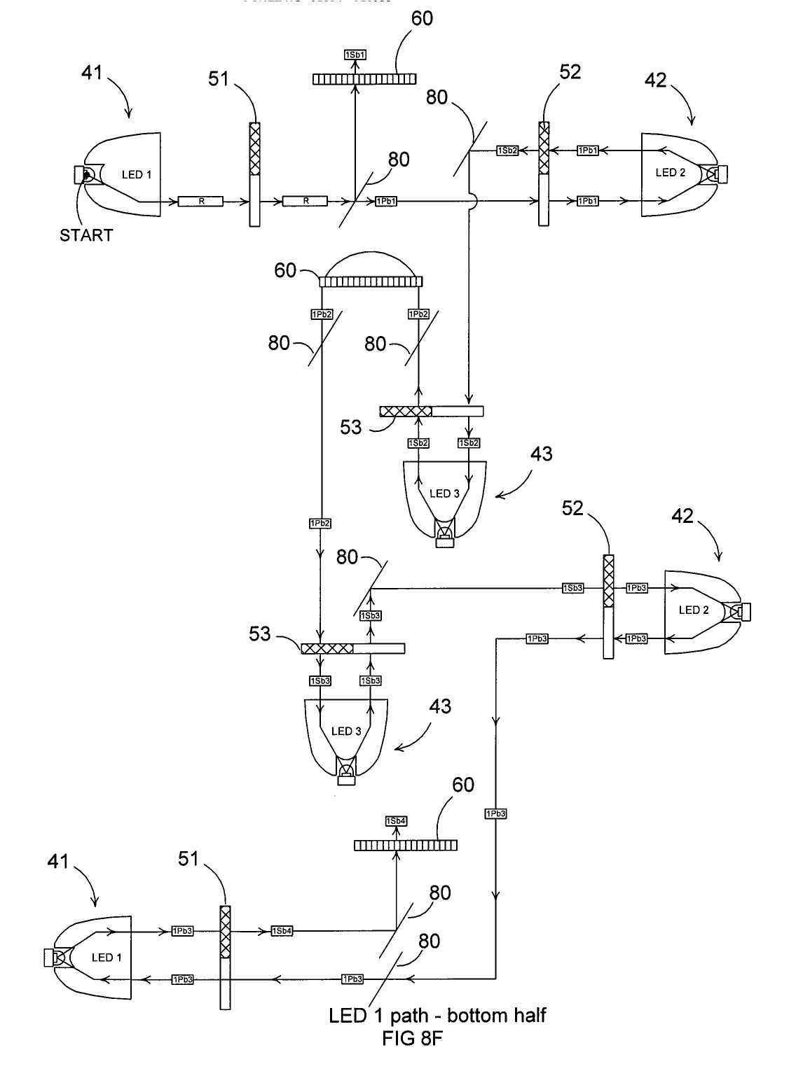

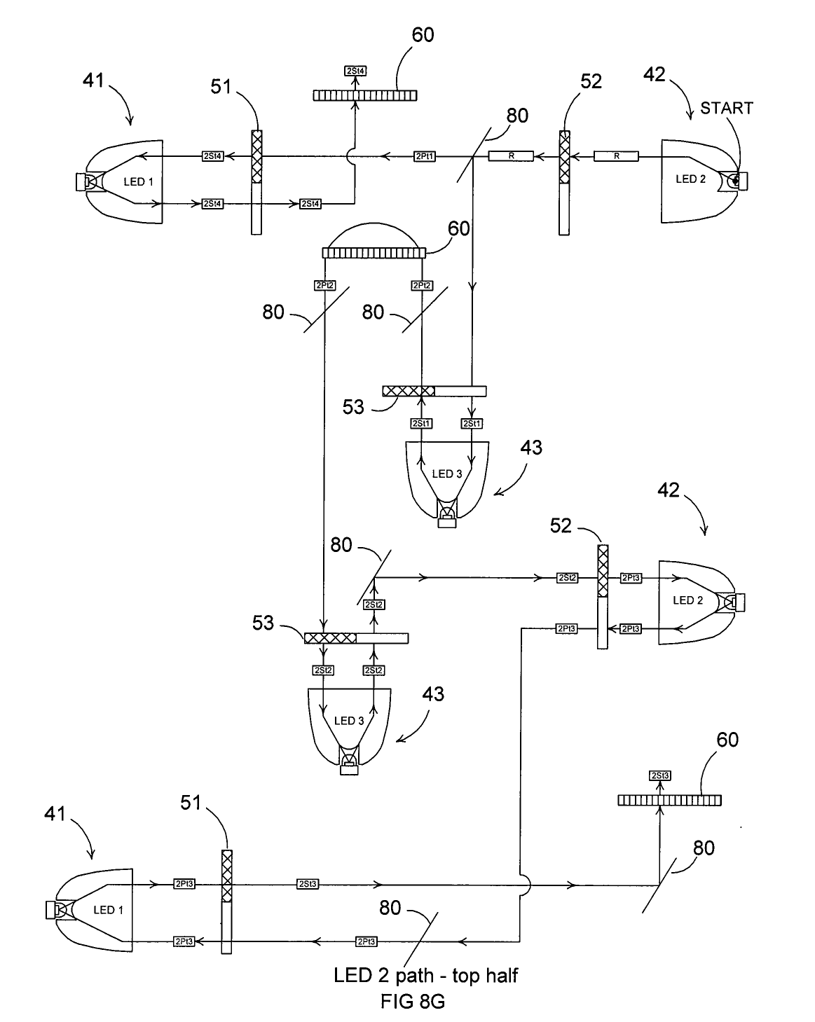

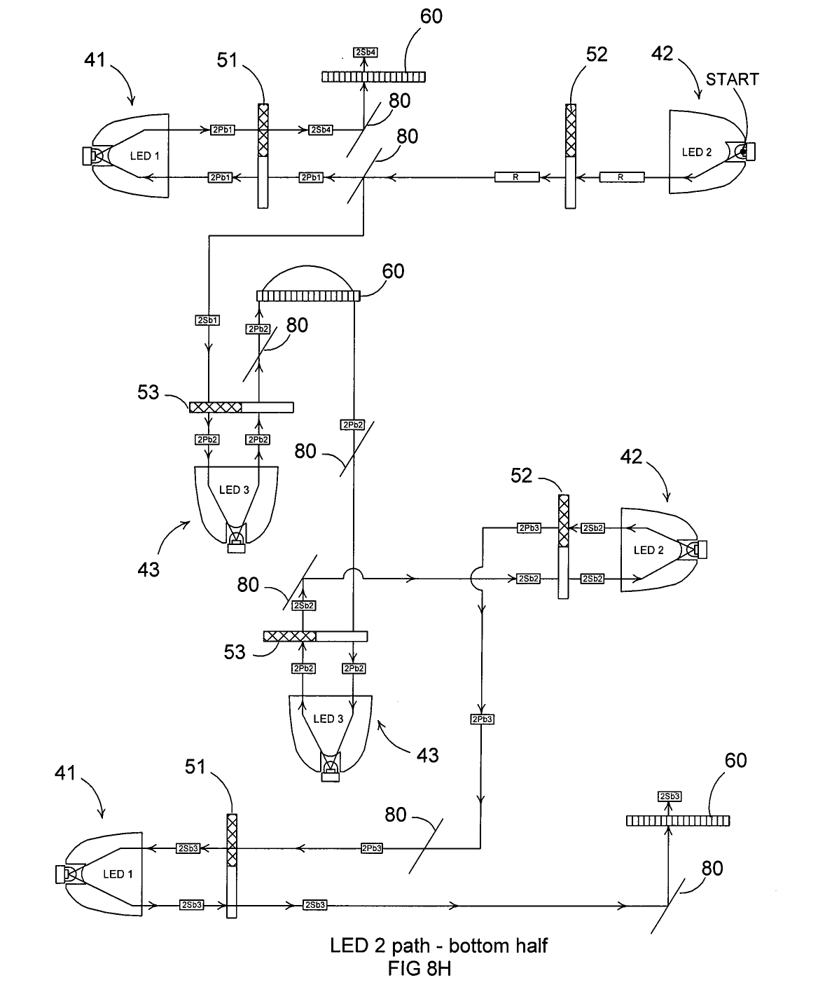

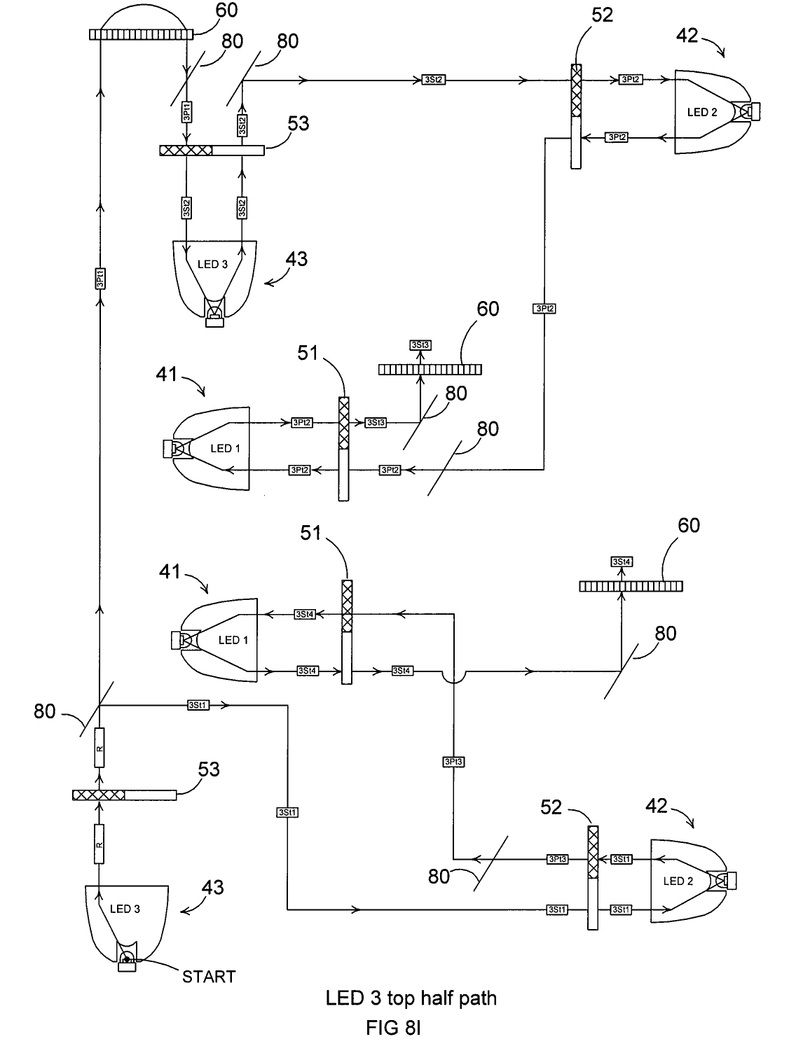

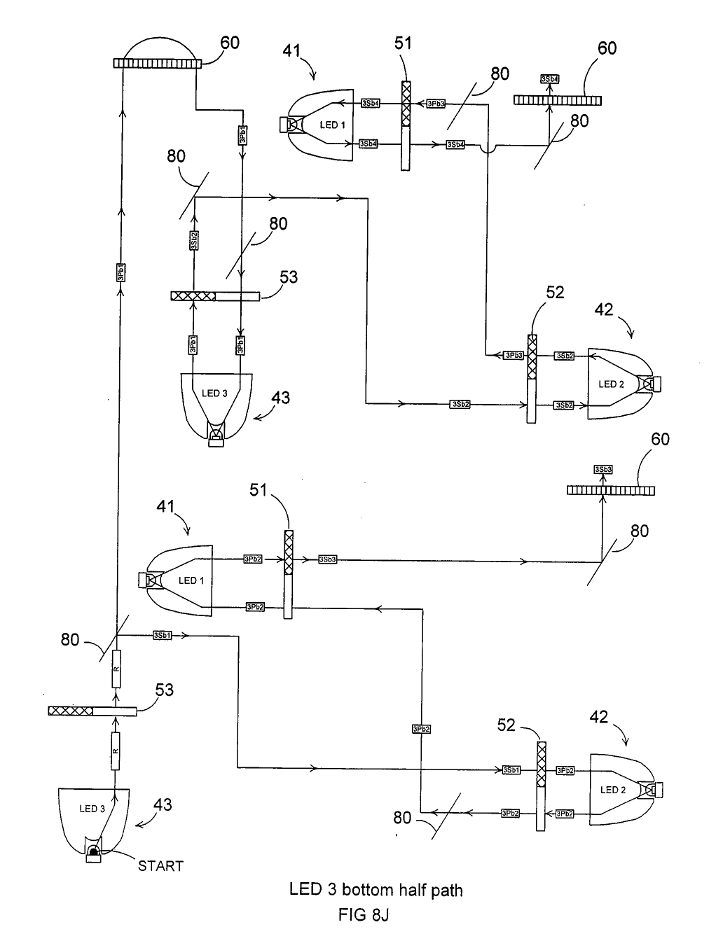

### H. Method and System of Exemplary Embodiments of FIGS. 8A-8J

FIG. 8A illustrates in diagram form a polarized light recycling method and system utilizing three light engines 41, 42 and 43 and ½ wave retarders. Light engine 41 is comprised of LED light source 11 with optic assembly 21, light engine 42 is comprised of LED light source 12 with optic assembly 22 and light engine 43 is comprised of LED light source 13 with optic assembly 23. All three are designed to project the light output parallel to the axis of their respective optic assemblies. Two of the three light engines 41 and 42 are positioned opposite each other so that light may be directed back and forth. The third light engine 43 is located 90 degrees from the opposing two light engines (as shown). ½ wave retarder 51 is positioned in front of the top portion of optic assembly 21, ½ wave retarder 52 is positioned in front of the top portion of optic assembly 22 and ½ wave retarder 53 is positioned in front of the top portion of optic assembly 23. PBS 80 is located between the three ½ wave retarders 51-53, as shown. On the opposite side of the PBS 80, opposing light engine 43 is reflective polarizer 60. Light is reflected back and forth between the three LED engines until it exits reflective polarizer 60 in the desired state of polarization (again, in this example, S polarized light). Since light engine 43 is positioned 90 degrees from the other LED sources, reflective polarizer 60 is required to reflect back the P polarized light for conversion to S polarized light.

In one or more embodiments envisioned by FIGS. 8A-8J, the light emanating from each LED source (11,12,13) takes one of two initial parallel paths. In one of the paths, the light initially passes through one of the ½ wave retarders (51, 52 or 53), and in the other path, it does not. This basically creates a top path (designated by “t” in the light path labels) and bottom path (designated by “b” in the light path labels). Light that passes through the ½ wave retarder is converted into the opposite state of polarization in a single pass while light that passes through the lower portion of the optics (i.e., not through the ½ wave retarder) is not converted and retains its original state of polarization. Thus, in this embodiment, each LED light source (11, 12, 13) creates four light paths (Pt, St, Pb, Sb).

Similar to one or more embodiments mentioned previously, the light output S is reflected off PBS 80 at 90 degrees off the optic axis. The twelve polarized light outputs (initially emanating from light engine 41, light engine 42, and light engine 43) are parallel to each other and perpendicular to the original light axis formed by at least light engine 41 and light engine 42. The total polarized light output is shown as 1St1, 1St4, 1Sb1, 1Sb4, 2St3, 2St4, 2Sb3, 2Sb4, 3St3, 3St4, 3Sb3, and 3Sb4. The path of light and the conversion from one state of polarization to the opposite state can be traced in FIG. 8B for light engine 41, FIG. 8C for light engine 42 and FIG. 8D for light engine 43. Likewise, flow diagrams of the light path are also depicted in FIGS. 8E-8J.

It should be understood that positional terms such as “top,” “below,” “in front,” “upward,” etc., are used only to better describe the relative positions of the components for purposes of understanding the embodiments, but that embodiment envisioned by FIGS. 8A-8J (as well as other embodiments described herein) are not limited to those precise positions.

In a lossless optical system, the embodiments described above may produce a polarized light output that is approaching nearly six times the polarized light output of a conventional LED and linear polarizer combination, with three times the amount of energy consumed. In addition the output area and etendue is substantially conserved resulting in a substantial gain in luminance from the source output aperture. Also, one or more embodiments of the present invention contemplate the location of the ½ wave retarder to substantially cover one of the half planes created by a line perpendicular to the optic axis.

### I. Method, Apparatus and System of Exemplary Color-Related Embodiments

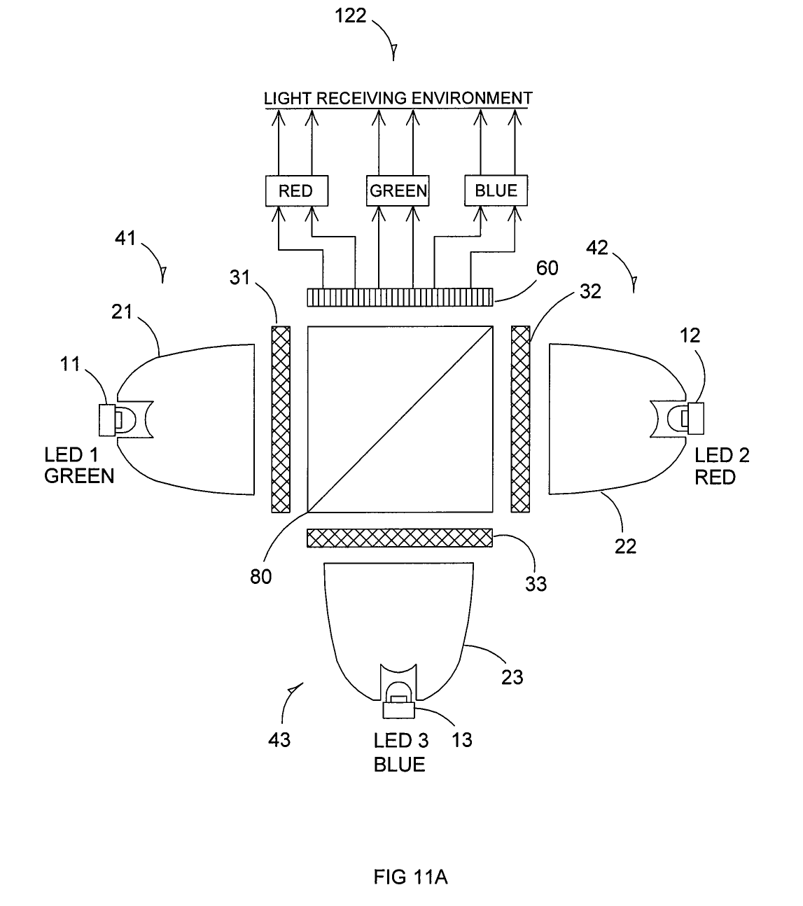

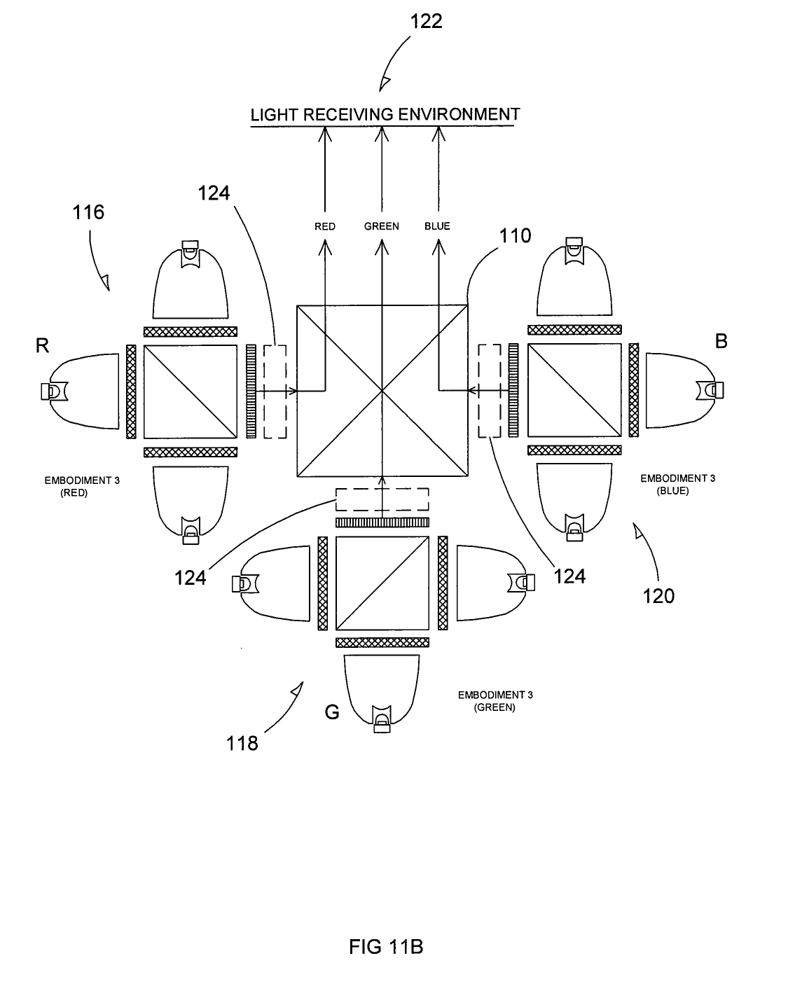

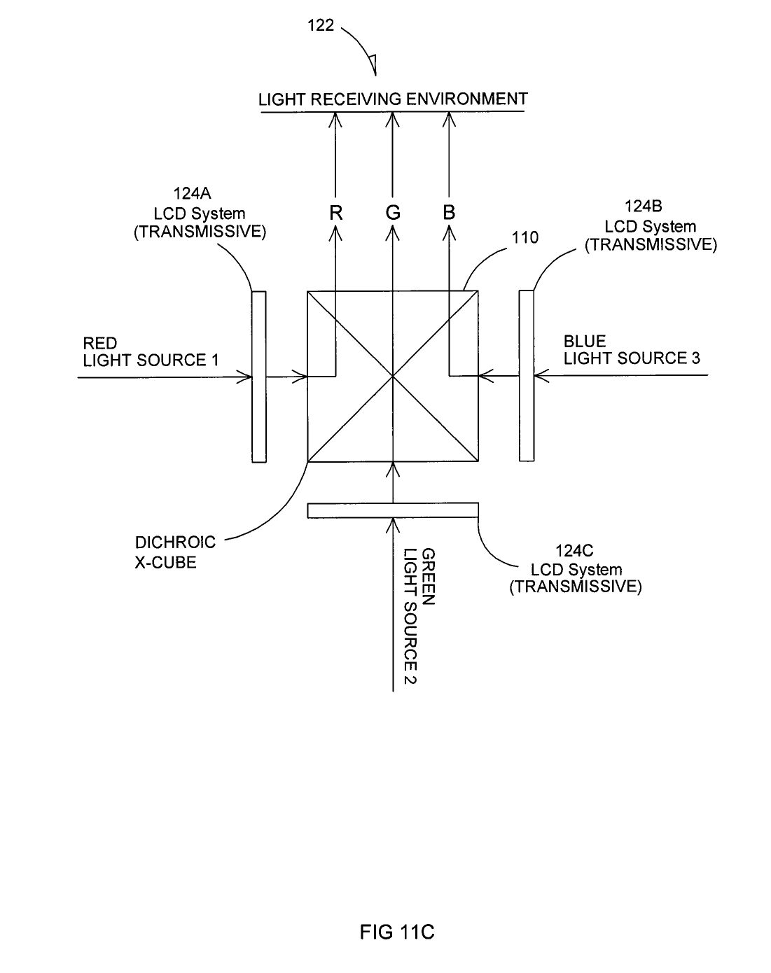

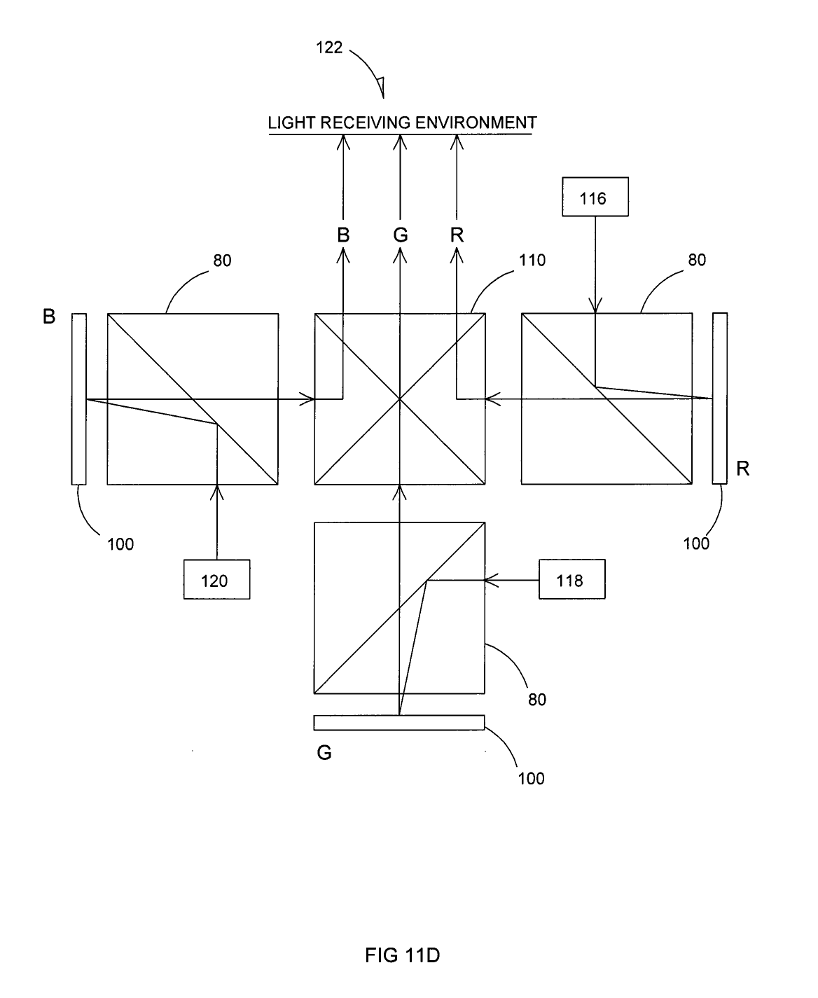

Embodiments of the present invention envisioned by FIG. 11A incorporate at least some aspects of previously-described embodiments (e.g., such as those of FIGS. 5A-5G) but contemplate using light sources with different wavelengths (e.g., red, green and blue). One or more embodiments envisioned by FIG. 11A contemplate that the output of these light sources (in this example, three light sources) can be combined and that these embodiments can be used in conjunction with (or as an integral part of) a highly efficient and compact video display system.

In general, various embodiments of the present invention envision that there are any number of different specific display and illumination technologies that can be used in conjunction with, or as an integral part of, those embodiments. For example, various LCD (liquid crystal display), LCoS (Liquid Crystal on Silicon), and DMD (Digital Micromirror Device) display technologies are contemplated, aspects of which will be discussed further below. Since certain key components of these technologies can require polarized light to function, embodiments such as those envisioned by FIG. 11A (as well as various other embodiments contemplated herein) can be used with those components without requiring additional light polarizing mechanisms. Though discussed herein primarily in the context of color imaging, it should be understood that these various display technologies are also envisioned for use with embodiments where only single-color LEDs are used if merely monochromatic images are desired.

In at least some embodiments of the present invention, efficiency differences can exist among light source positions due to the number of reflections. For example, in one or more embodiments envisioned by FIG. 11A, the most efficient light source position is LED1, since light emitted therefrom will incur the fewest light reflections before exiting as polarized light through reflective polarizer 60 (see, for example, FIGS. 5B-5G above for an indication of reflection paths). Thus, for purposes of using the resultant light in a color display system, a green LED can be associated with light engine 42 since more green than red or blue is typically required in display systems. Second is light engine 42 which can have a red LED associated with it, and last is light engine 43 which can have a blue LED associated with it (since typically blue is required less than the other two colors).

For reasons described above, the various light polarizing and recycling concepts described herein can result in a highly efficient polarized light output of sufficient flux and etendue to support the needs of video display systems. Another desirable video capability made possible by various embodiments of the present invention is compact size of the resultant video display system. Utilizing three light sources with an output etendue equal to a single source, one or more embodiments of the present invention can be smaller than conventional video display systems. (An example of a conventional video display system is the Epson PowerLite Home Cinema 1080 from Seiko Epson Corporation of Nagano, Japan.)

One reason contributing to smaller size is that embodiments of the present invention do not require additional mechanisms to separate white light (emanating from, e.g., a mercury lamp), into red, green and blue light. Instead, the required red, green and blue light is directly generated by red, green and blue light sources such as colored LEDs. Also, because of the light recycling as explained above, the individual light sources can be less powerful (and smaller) than would otherwise be needed. In addition, as mentioned above, various embodiments for light recycling as described herein have already polarized the light, making it usable in, e.g., LCoS or LCD devices without the need for additional polarizing devices.

Still referring to FIG. 11A, it should be understood that the polarized red-green-blue (RGB) light shown as being directed to light receiving environment 122 is a general depiction, and that individual colors can be directed to the light receiving environment 122 in ways (and to specified components therein) that are known to those skilled in the art, depending upon the technology and application being used. Components relating to any number of different technologies and applications are envisioned for possible use (e.g., as part of light receiving environment 122), including LCoS, LCD, DMD and various general illumination technologies and components (e.g., a projection lens, light delivery lens, reflector, etc.).

Embodiments envisioned by FIG. 11A can be constructed of typical components used in optical assembly, such as those supplied by Edmund Optics of Barrington, N.J. The LCoS panels, themselves, can be obtained by, e.g., Syntax-Brillian of Tempe, Ariz. For various embodiments of the present invention utilizing light sources of differing wavelengths and components envisioned for use therewith, broader spectrum optical components may be desirable. Different broadband optical components are available, and are well known by those in the field. For example, retarders that are achromatic in nature, broadband beam splitters, wire grid polarizers and collimation optics designed for broad spectrum are well known and can be used.

Various embodiments described herein (such as embodiments envisioned by FIG. 11A) and components envisioned thereby can be combined together to create an efficient, color display system having additional intensity. More specifically, referring to FIG. 11B, light engine cluster 116 includes three light engines, each having a red LED. Similarly, light engine cluster 118 includes three light engines with green LEDs, and light engine cluster 120 includes three light engines with blue LEDs. The light from each of these light engine clusters can be combined using a dichroic prism (X-cube) 110 and directed to a light receiving environment 122.

In one or more embodiments of the present invention, the configuration shown in FIG. 11B will yield a system that is typically physically larger than those envisioned by FIG. 11A (due to use of multiple light sources), though it still can provide an output having etendue equal to a single source. In comparison to at least some embodiments envisioned by FIG. 11A, the intensity for each color in the configuration of FIG. 11B may be greater. Consequently, systems and methods based upon one or more embodiments envisioned by FIG. 11B can be used for applications where, for example, especially bright light sources are required.

As with various other color-related embodiments mentioned herein, one or more embodiments envisioned by FIG. 11B can be used as part of (and/or in conjunction with) various types of imaging and/or display technologies, and the components relating thereto are known and readily obtainable as indicated above. For example, block 124 indicates where certain video technology can be positioned to allow light from each of the light engine clusters to pass through so that, in conjunction with light receiving environment 122, an image can be displayed.

In general, it should be understood that various embodiments of the present invention envision additional numerous configurations of light engines (having, e.g., red, green or blue light LEDs) using, for example, various components (or the like) shown in FIG. 3. It should also be understood that one or more embodiments of the present invention contemplate that a combination of colors other than RGB can be used, and/or that a combination of four or more LED colors (e.g., four light engines each containing a red, green, amber or blue LED representing four “primary” colors) could be used. Where four or more colors are used, color mixing techniques and components such as those described in U.S. patent application Ser. No. 11/577,861 (which is incorporated herein by reference in its entirety) could be applied.

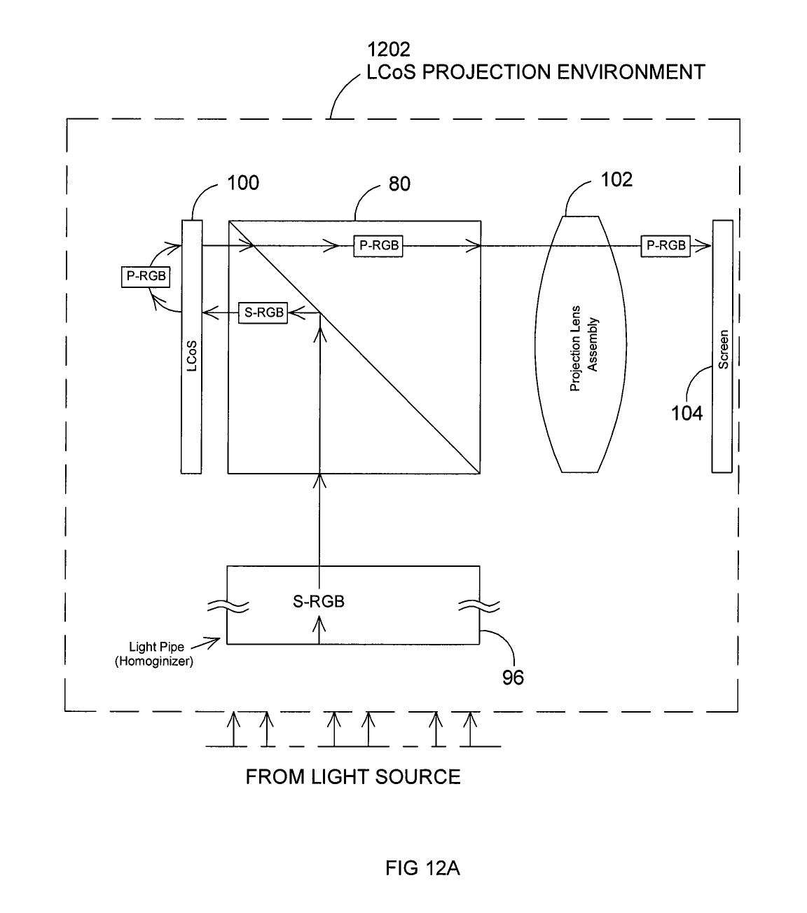

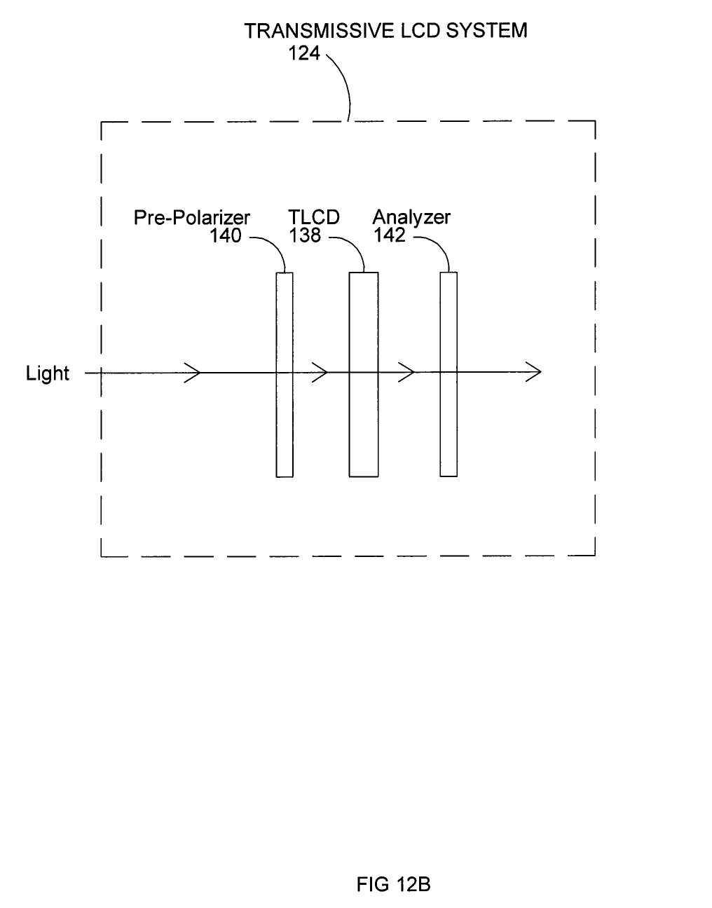

As mentioned above, LCD imaging technology is one example of technology that can be used in conjunction with (or as an integral part of) various color LED embodiments of the present invention. Embodiments for using transmissive LCD technology, in particular, are now discussed with regard to FIG. 11C. Referring to FIG. 11C, the light from each of the red, green and blue light sources are passed through a transmissive LCD (124a, 124b and 124c, respectively). The source of each light color can be generated using any number of the light-generating embodiments contemplated herein, including those envisioned by FIG. 11A or 11B. The X-cube 110 receives the light transmitted through each transmissive LCD, and directs the light to the light receiving environment 122. In various embodiments, each LCD (124a, 124b and 124c) could actually be an LCD system (as shown in FIG. 12B) having, for example, the components of a pre-polarizer 140, a transmissive LCD component 138 and an analyzer 142. In addition to transmissive LCDs, it should be understood that embodiments of the present invention envision that any number of different types of transmissive picture or video technologies could also be used.

As also mentioned above, LCoS imaging technology is another example of technology that can be used with (or as part of) various color LED embodiments of the present invention. Embodiments for using LCoS technology are now discussed with regard to FIG. 12A. Referring to FIG. 12A which shows an LCoS projection environment 1202, light from a light source (generated, for example, using any number of the light-generating embodiments contemplated herein) enters a light pipe 96 and is directed to polarized beam splitter 80. As indicated in this example, the light has a predominantly S component, and is reflected by the polarized beam splitter 80 toward the LCoS 100. In this example, when it is desired that a particular LCoS pixel is to be reflective, the reflected light is shifted so that it, instead, is converted to having a predominantly P component. The P components then pass through the polarized beam splitter 80 to the projection lens assembly 102 and onto the screen 104. Various embodiments also contemplate use of a pre-polarizer (optically between light pipe 96 and polarized beam splitter 80) and/or an analyzer (polarized beam splitter 80 and projection lens assembly 102), not shown.

The configuration using the polarized beam splitter 80 as shown allows the light reflected by the LCoS 100 to reach the screen 104 while preventing light emanating from the light pipe 96 from directly reaching the screen 104 (prior to being directed to the LCoS 100). However, it should be understood that embodiments of the present invention envision additional numerous configurations for performing the same or similar functions using, for example, the various components (or the like) of FIG. 3.

For simplicity of description, FIG. 12A depicts “RGB” light emanating from a “light source” (having substantially only an S component) and reflecting off of a single LCoS 100. In such an embodiment, it is envisioned that the primary color lights (e.g., red, green and blue) can be cycled to reflect off of LCoS 100 (using known optical time division multiplexing technology. Thus, the color of the “light source” can be cycled through red, green, and blue at a frequency beyond which the human eye can perceive. Alternatively, a filter (not shown) for each primary color can be used in conjunction with the LCoS panel positioned such that light directed to and/or reflected from the LCoS panel passes through the filters (which collectively can be thought of as a compound filter). The compound filter can be manipulated to allow or prevent transmission of their designated primary color. In one or more embodiment, this manipulation can be cycled through each color for the entire compound filter, in which case the LCoS 100 cycles accordingly in view of the color being transmitted by the compound filter and that color's component with regard to the current image. In other (or alternate) embodiments, portions of the compound filter can be manipulated at the pixel level such that the color associated with each individual pixel of the LCoS 100 can be controlled. In that situation, the LCoS 100 and filters need not be cycled in the manner mentioned above. These types of compound filters (which can be, e.g., an RGB filter) can be obtained from a number of sources, including Integrated Microdisplays Ltd., of HongKong, China.

In at least some of the LCoS 100 embodiments of the present invention mentioned above, a light source such as depicted by FIG. 11A could be advantageously used in conjunction with such a compound filter, since a significant portion matches its transmission characteristic. In general, it should be understood that various other types of light sources could also be used, and that the usage of filters is not limited to use with LCoS technology (e.g., it could be used with various types of LCDs).

Alternatively, where multiple LCoS are used, one or more embodiments of the present invention envision, for example, a configuration somewhat akin to FIG. 11C, except that the LCoS 100 would replace the LCDs (124a, 124b and 124c). Such a configuration is generally depicted by FIG. 11D. Referring to FIG. 11D, the light reflecting from each LCoS 100 could then, for example, be directed to X-Cube 110 as shown, and then be directed to a light receiving environment 122. Again, these individual components and their functions are well known by those skilled in the art.

In addition to utilizing additional LEDs to create a more intense light output, another advantage to embodiments envisioned by FIG. 11B is that, during the light recycling process, the light from each LED is reflected off only those LEDs of the same wavelength. Thus, for example, in light engine cluster 116, during the light recycling process, the light reflected by any of the red LEDs therein will always be red. An advantage here is that an LED will typically reflect light of its own wavelength more efficiently than light of a different wavelength.

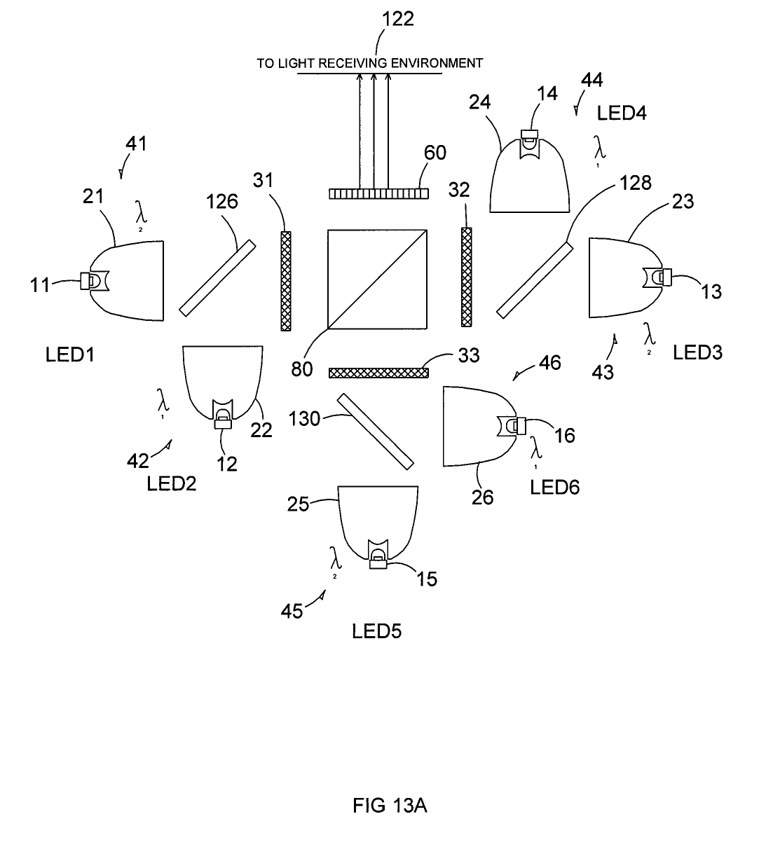

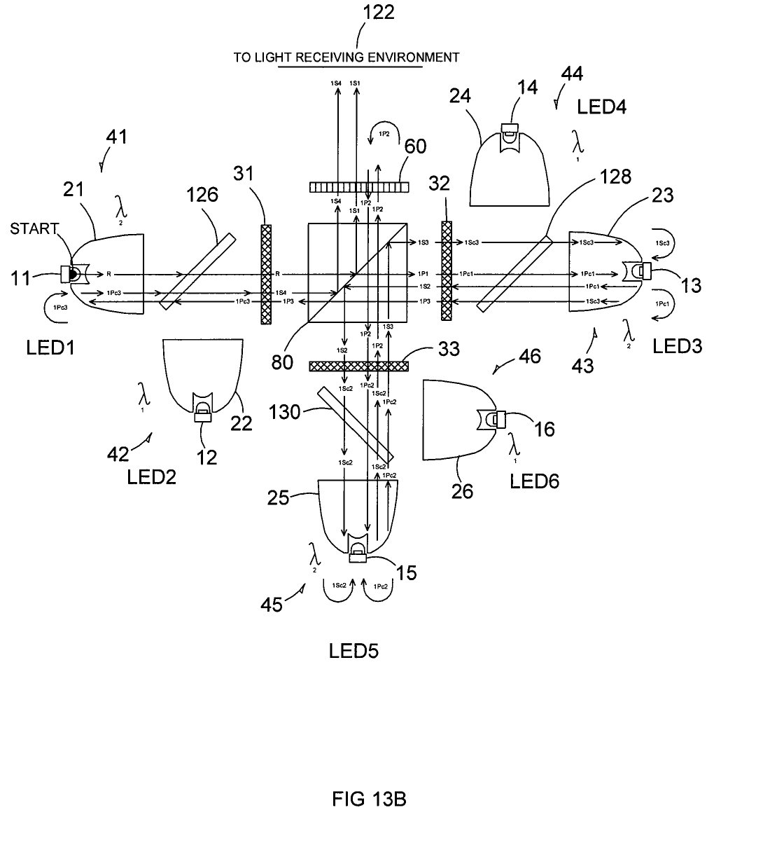

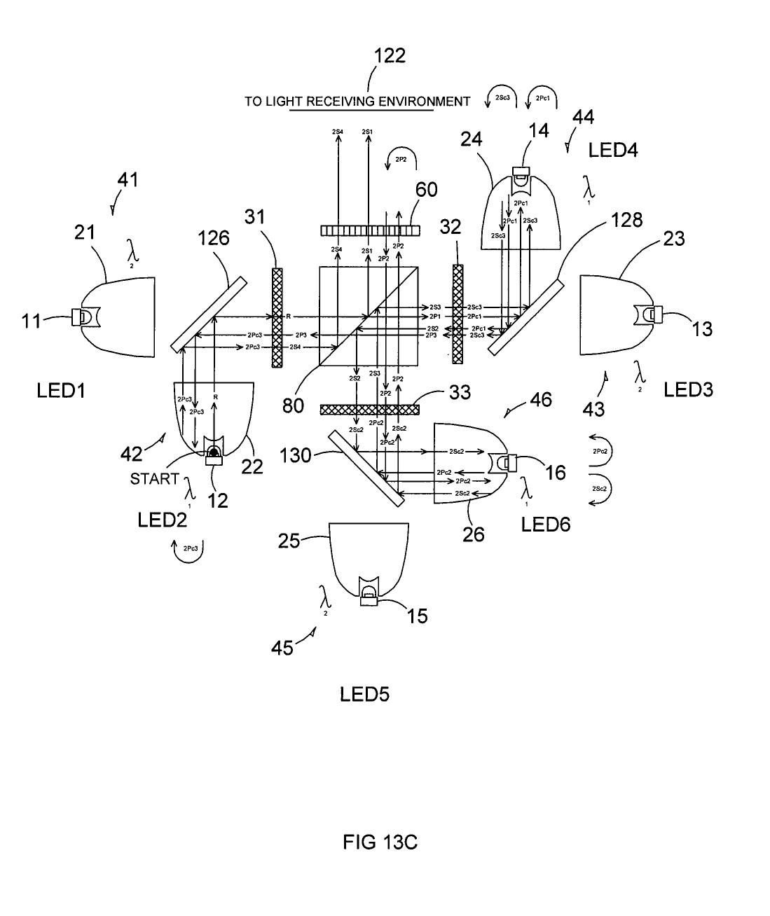

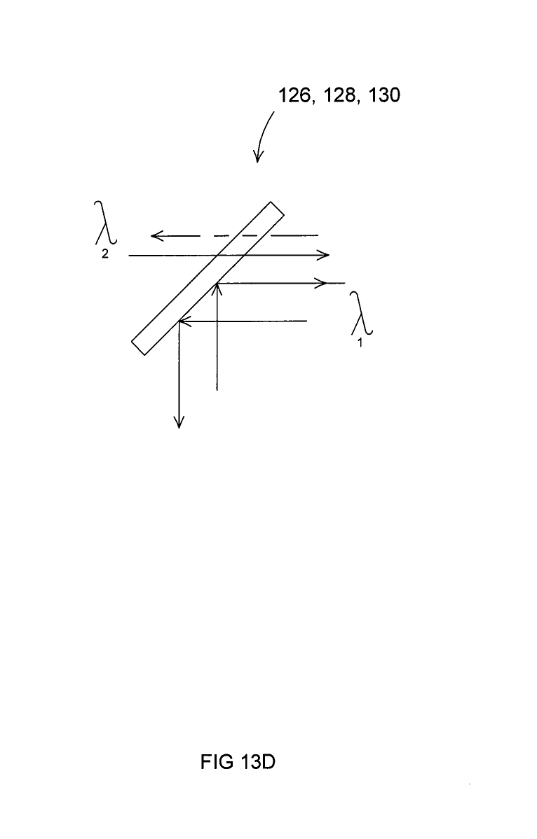

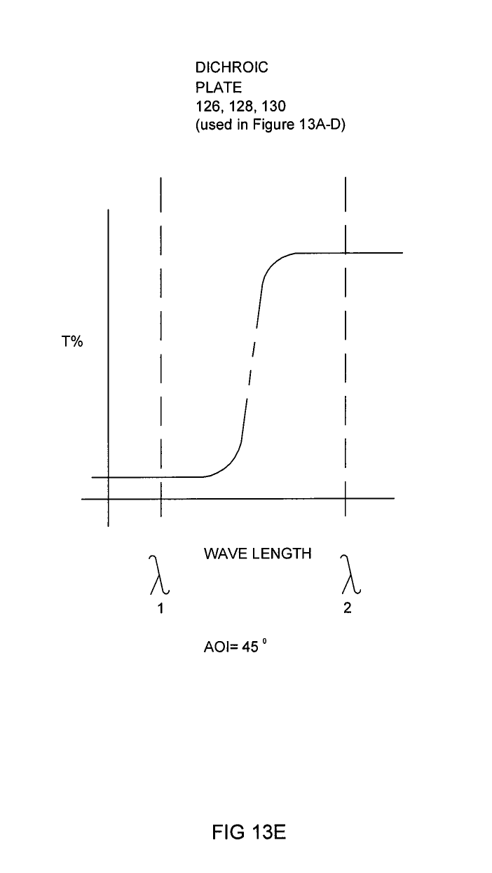

With the above concepts in mind, FIGS. 13A-13D show embodiments using angled dichroic plates (126, 128, 130) that are set at a given angle (e.g. 45 degrees) and that reflect light with a first wavelength λ₁ while allowing light with a second wavelength λ₂ to pass through. In at least some embodiments envisioned by these Figures, light of a given wavelength is reflected off only those LEDs having a like wavelength. FIGS. 13A-13D specifically show use of two different colors of LED. However, this is merely for example purposes, and it should be understood that embodiments envisioned by FIGS. 13A-13D also contemplate use of additional components or dichroics with different characteristics so that additional colors could also be included and so the light generated therefrom could ultimately be directed to light receiving environment 122.

Referring to FIG. 13A, it is envisioned that LEDs 11, 13 and 15 are of like color, and that light of this color will pass through (and is not reflected by) dichroic plates 126, 128 and 130. The light paths for this color (wavelength represented by λ₂ in this example) follow at least substantially the same path as that in embodiments of FIG. 5B-D, since the pertinent part of the configuration is substantially similar. Thus, for example, in FIG. 13B, the path of light emanating from light engine 41 (LED 11) follows essentially the same path as shown by light emanating from light engine 43 in FIG. 5B. In various embodiments envisioned by FIG. 13B, however, the light is reflected only off of those LEDs having the same wavelength (e.g., λ₂) as the source. In FIG. 13D, it is diagrammatically shown how the dichroic will reflect one wavelength but transmit another.

FIG. 13E is a graph indicating how the dichroic plate, at an angle of 45 degrees, will transmit essentially all of wavelength λ₂ and essentially none of wavelength λ₁.

FIG. 13C depicts the light path emanating from light engine 42 having an LED(s) of color/wavelength λ₁. As indicated, this is the wavelength that is reflected by the dichroic plates 126, 128 and 130. Again, as shown, light from light engine 42 is reflected by only those LEDs of the same wavelength.

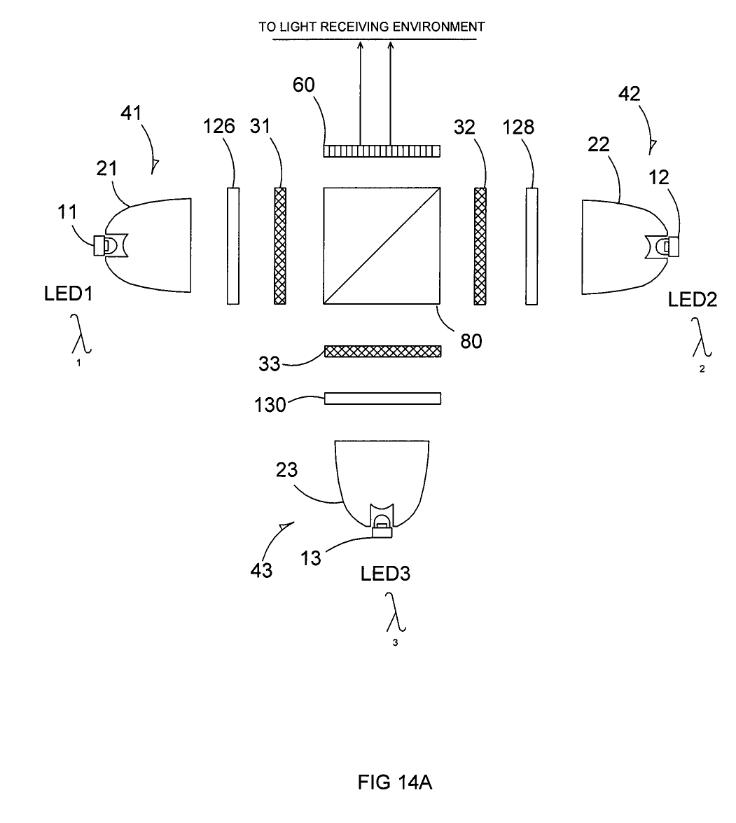

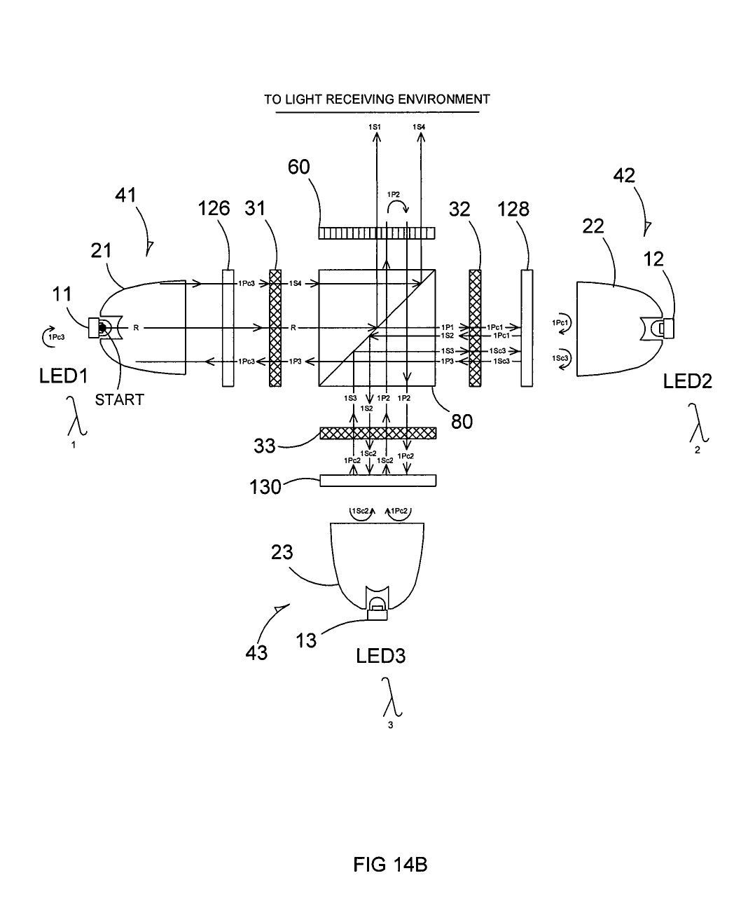

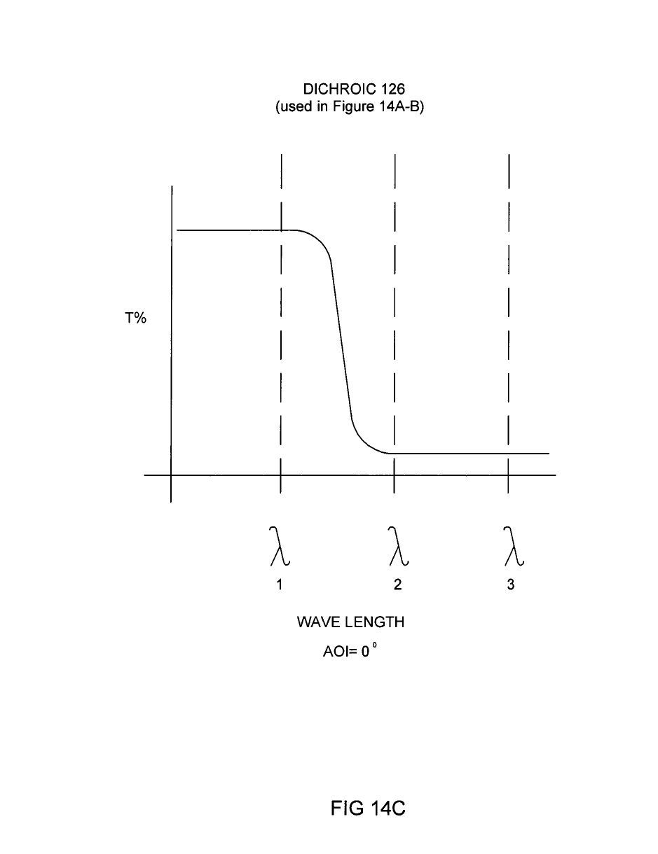

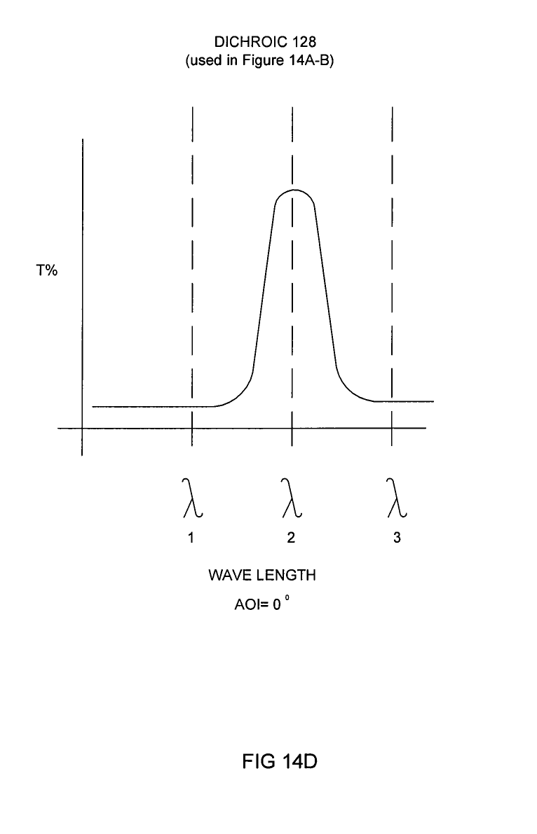

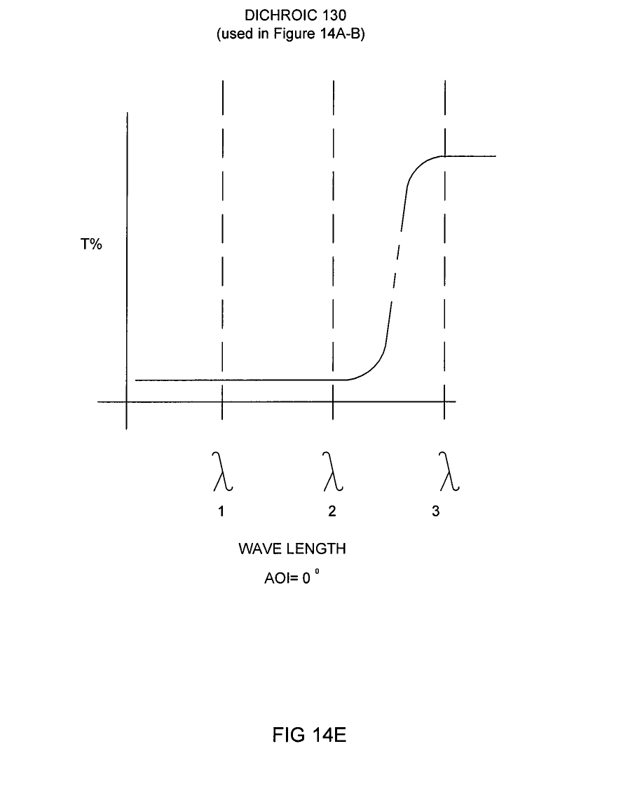

Referring to FIGS. 14A-14E, one or more embodiments of these figures envision using dichroic plates 126, 128 and 130 for, in effect, preventing the LEDs from reflecting light of a wavelength other than their own, using dichroic plates oriented perpendicular to the direction of the light beams directed at them. Specifically, referring to FIG. 14A, three light engines 41, 42 and 43, are shown, each having an LED of a different wavelength (for example, wavelengths representative of red, green and blue). As can be seen, the basic components and orientations thereof are those of FIG. 5A, except that here in FIG. 14A, dichroic plates (126, 128 and 130) are located between the light engines (41, 42 and 43) and ¼ wave retarders (31, 32, 33), as shown. In various embodiments contemplated by this FIG. 14A, each dichroic plate is envisioned to transmit the wavelength of light transmitted by the light engine adjacent to, and to reflect the other two wavelengths. Thus, for example, dichroic plate 126 will transmit the light of wavelength λ₁ (emanating from light engine 41) but reflect the light of wavelengths λ₂ and λ₃ emanating from light engines 42 and 43, respectively.

FIG. 14B depicts the light path followed by light emanating from light engine 41 having an LED wavelength λ₁. As can be seen, by virtue of dichroic plate 126 transmitting this wavelength and dichroics 128 and 130 reflecting it, the only LED that ends up reflecting wavelength λ₁ is the one from which the light emanated (i.e., LED 11). Though the light paths for LEDs 12 and 13 are not shown herein, it should be understood that the same functional result would occur in each case.

FIGS. 14C-14E indicate the wavelengths reflected and transmitted by each of the respective dichroic plates mentioned above. Specifically, dichroic plate 126 transmits substantially only wavelength λ₁, dichroic plate 128 transmits substantially only wavelength λ₂, and dichroic plate 130 transmits substantially only wavelength λ₃.

It should, of course, be understood that the use of dichroic plates 126, 128 and 130 to achieve the function of reflecting light off of only LEDs of like color as shown by FIGS. 13A-14E are by way of example, and that embodiments of the present invention contemplate numerous additional configurations using dichroic plates and other optical devices of various number and type.

Various embodiments of the present invention envision a very compact LCoS projection system using at least some of the components (and positioning thereof) in a substantially similar way to that shown in at least some embodiments described above. In general, one or more light engines are envisioned to contain, for example, a number of LEDs (either positioned very close together, or else a single LED having multiple dies) having different color, for example, a blue, red, and two green LEDs. The reasons for having two green dies is that the color green is often the most prevalent in display systems, as discussed above. The light from LEDs would be cycled sequentially using some type of known optical time division multiplexing technology, as indicated above, then reflected off of an LCoS using a polarizing beam splitter, and then directed to a projection lens.

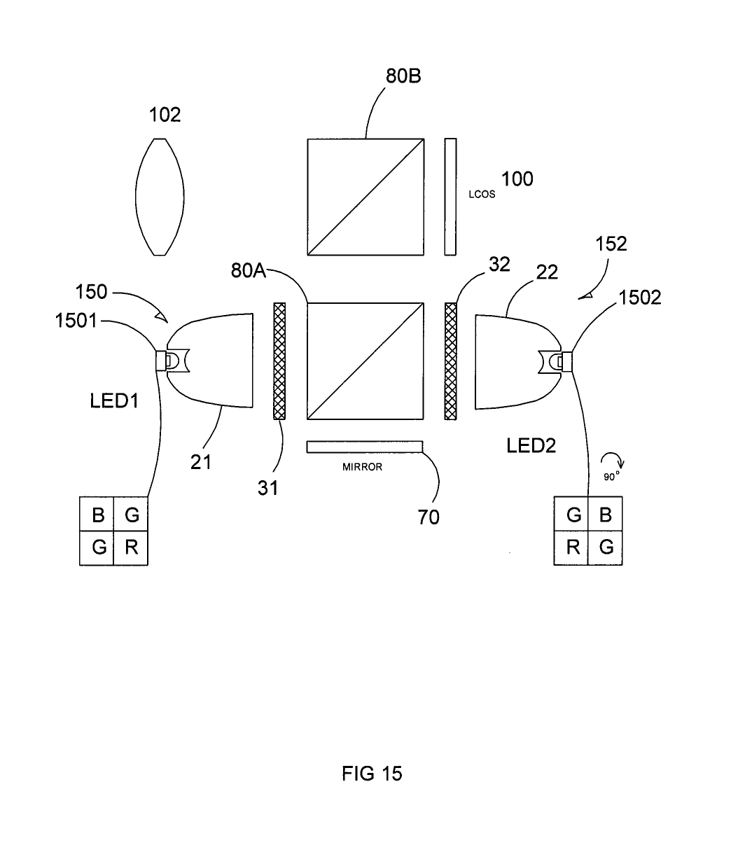

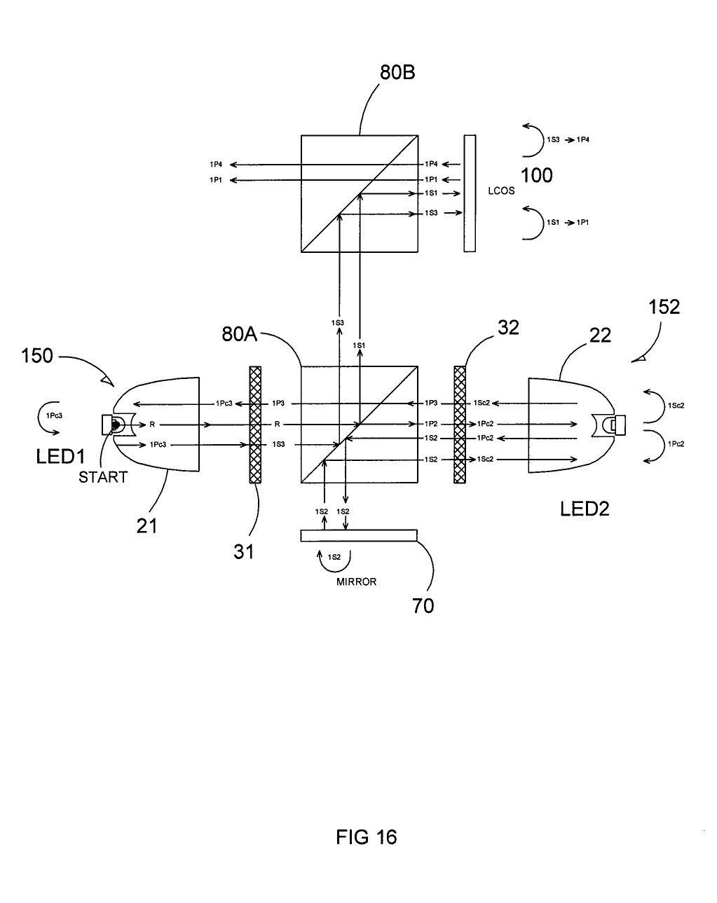

A more specific example of the embodiments described above is shown by FIGS. 15-16. Referring to FIG. 15 (depicting 2 light engines for purposes of example), the positioning of the light engines (150, 152) quarter wave retarders (31, 32), polarizing beam splitter 80A and mirror 70 are akin to various components shown in FIG. 4A. Similarly, the light paths from LEDs 1501 and 1502 will also be akin to those of LEDs 11 and 12 (respectively) of FIG. 4A. However, in embodiments envisioned by these Figures, light from light engines 150 and 152 cycles through the available colors with time. At any given point in time, embodiments of the present invention envision that LEDs (or groups of LEDs) 1501 and 1502 display the same or substantially the same color.

FIG. 16 depicts the light path emanating from light engine 150. As can be seen, this is akin to the light path of light engine 41 in FIG. 4B. In one or more embodiments envisioned by FIG. 16, when the light leaves polarizing beam splitter 80A (i.e., and is directed toward polarizing beam splitter 80B), it is reflected by polarizing beam splitter 80B, reflected in pertinent part off of LCoS 100, and transmitted through to the opposite end of polarizing beam splitter 80B from LCoS 100, as shown.

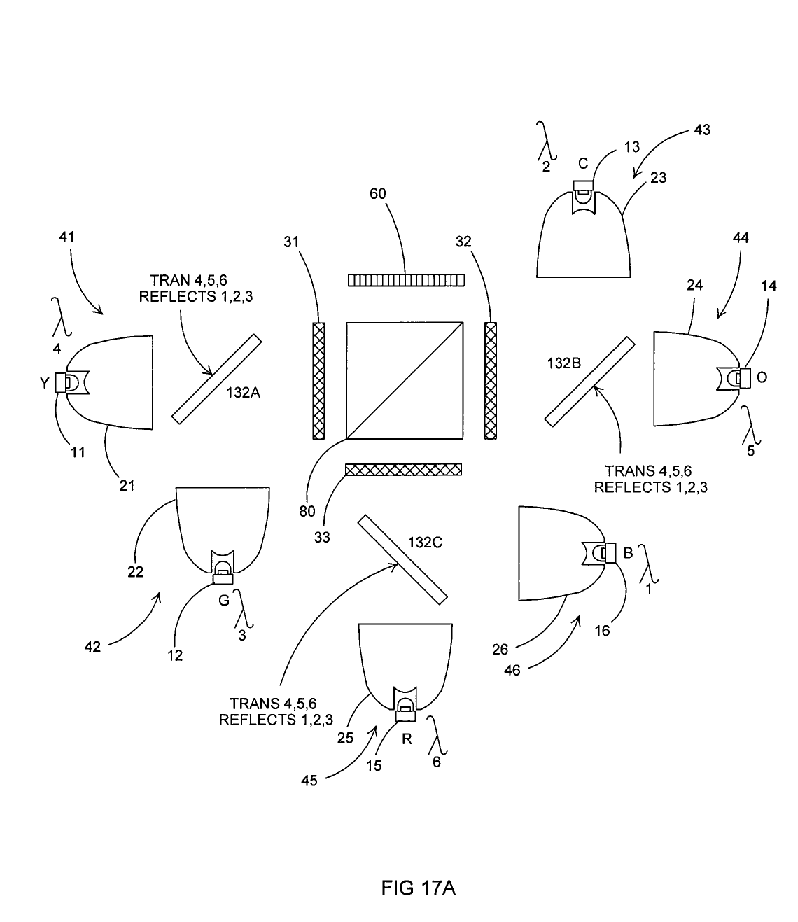

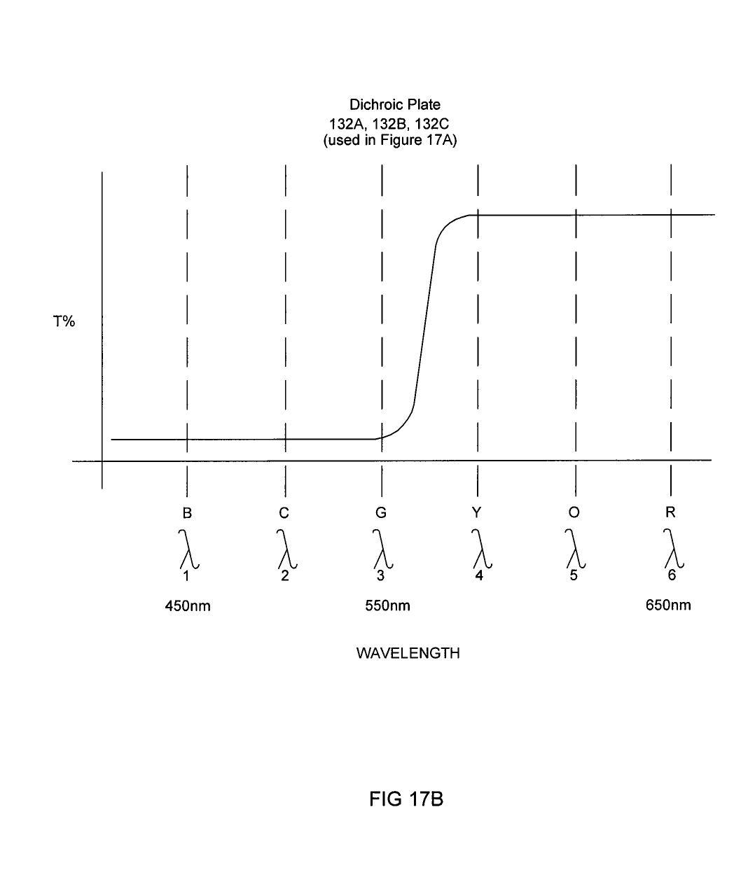

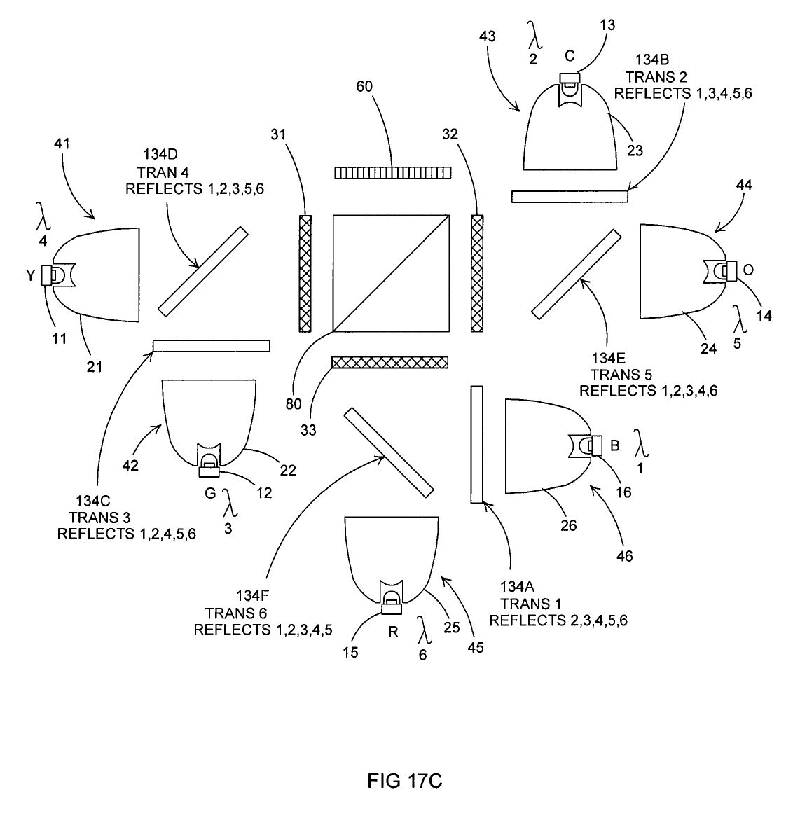

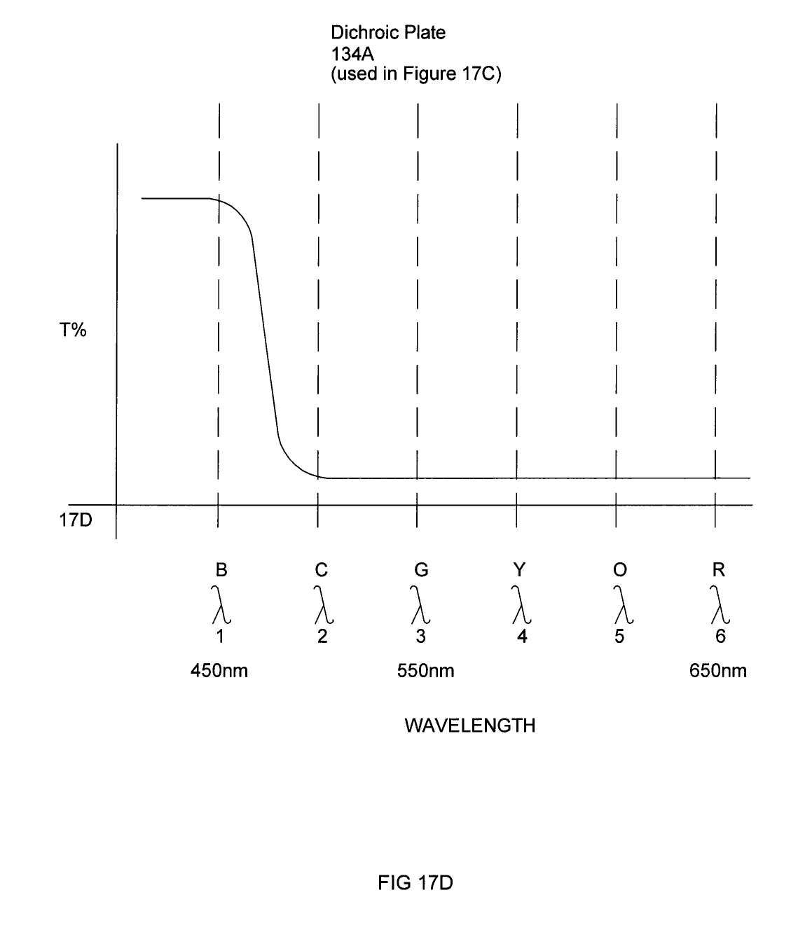

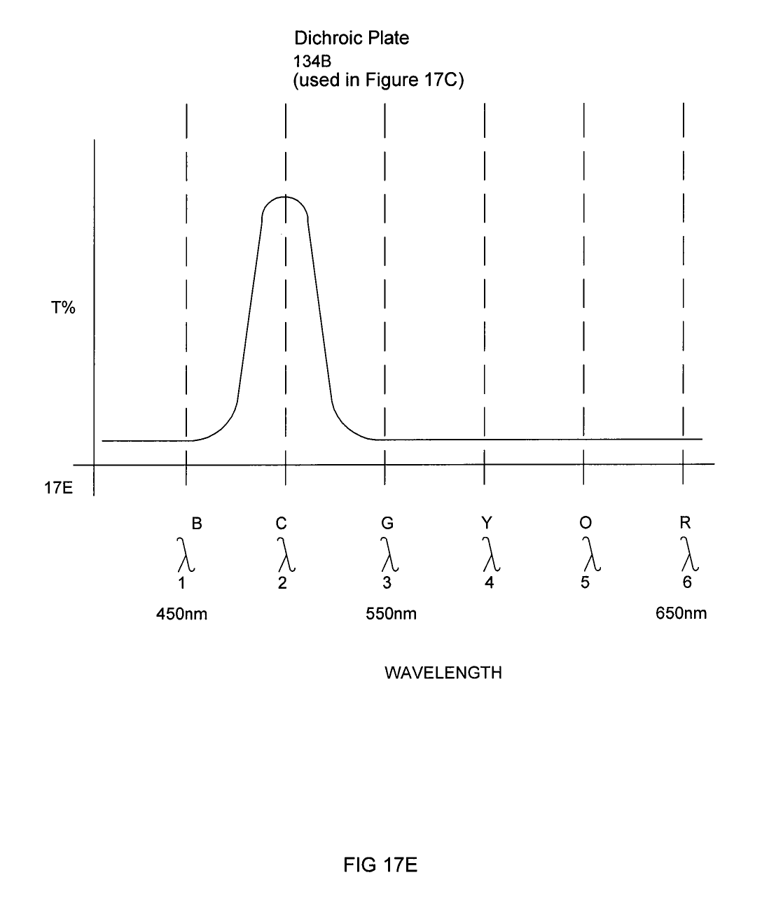

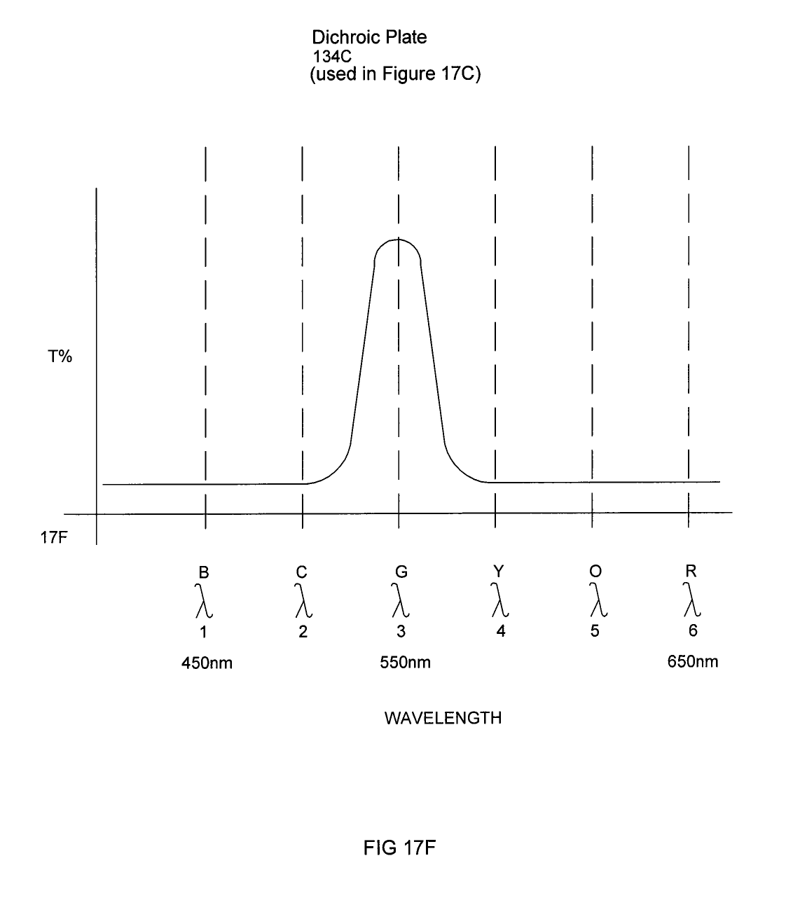

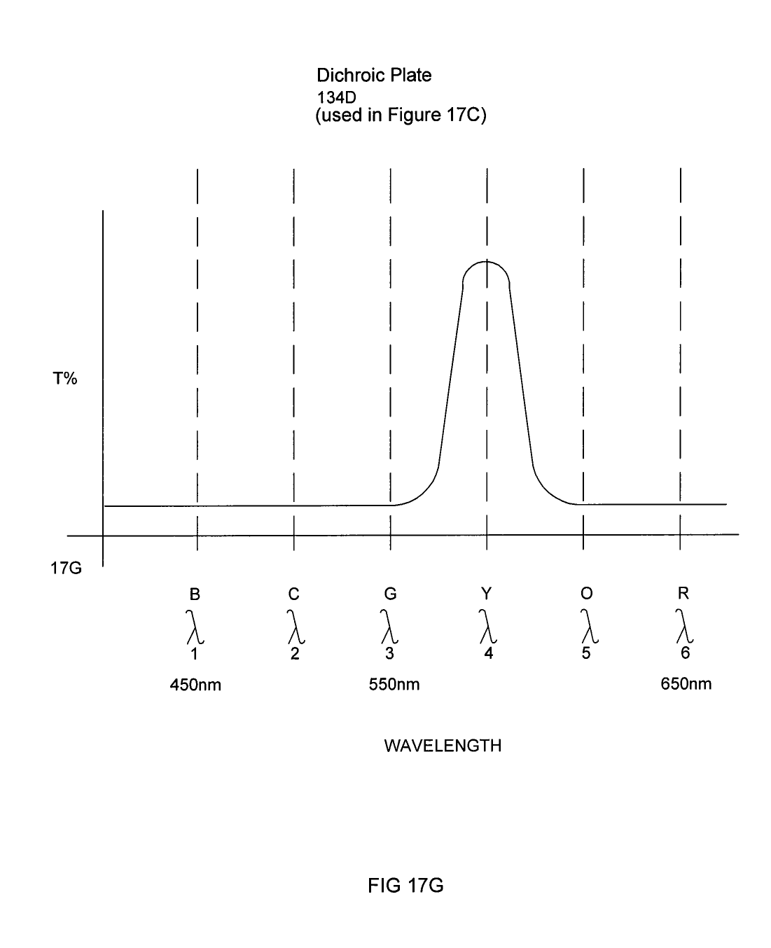

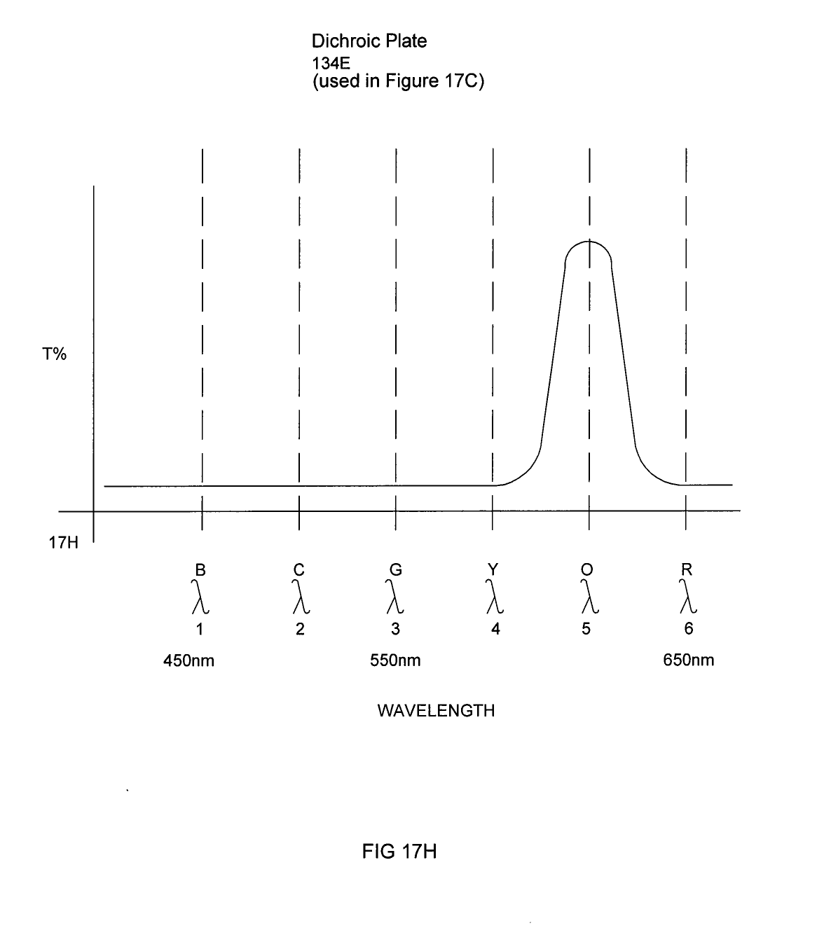

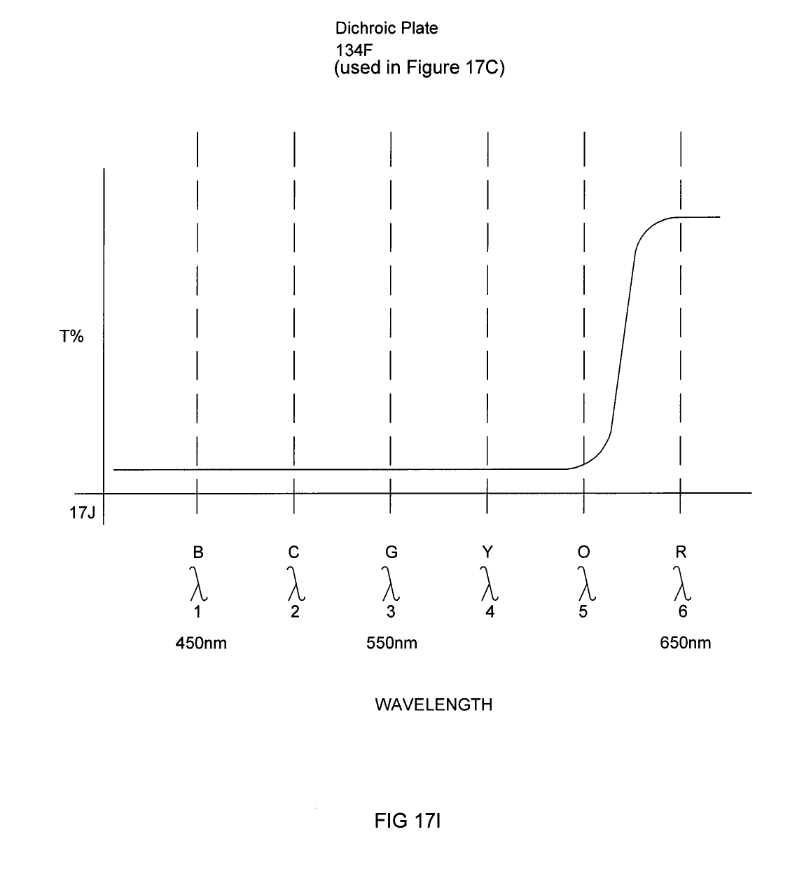

FIGS. 17A-17B show embodiments using angled dichroic plates (132A, 132B, and 132C) that are set at a given angle (e.g. 45 degrees) and that reflect light having wavelengths λ₁, λ₂, and λ₃ while transmitting light having wavelengths λ₄, λ₅, and λ₆. In effect, this embodiment depicts a six-wavelength version (in terms of components and light path) of various embodiments of FIGS. 13A-C. In embodiments depicted by FIG. 17A, however, the LEDs will reflect light other than that of their own wavelength.

FIG. 17B indicates the wavelengths reflected and transmitted by each of the respective dichroic plates mentioned above. Specifically, the dichroic plates 132A, 132B, and 132C are shown as substantially transmitting wavelengths λ₄, λ₅, and λ₆, and substantially reflecting wavelengths λ₁, λ₂, and λ₃.

FIG. 17C depicts other six color embodiments using angled dichroic plates (134D, 134E, and 134F) and non-angled dichroic plates (134A, 134B, and 134C) such that each LED will reflect only its own wavelength, using the concept akin to that described in FIGS. 14A-14B.

FIGS. 17D-17I graphically depict the wavelengths reflected and transmitted by each of the respective dichroic plates mentioned above.

Of course, it should be understood the embodiments of FIGS. 17A-17I (as well as various other embodiments herein) are not limited to six LEDs or six wavelengths, Nor are they limited to use of ¼ wave retarders (e.g., ½ wave retarders could also be used, as depicted in previous embodiments).

### J. Pulsing LED Sources to Improve System Performance

To further increase the efficiency and light output of the system utilizing LED light sources, pulsing methods can be combined with the above recycling methods utilizing multiple light sources. By rapidly switching, or pulsing, the current to a LED light source, the peak intensity can be higher than the peak intensity when operated under continuous current.

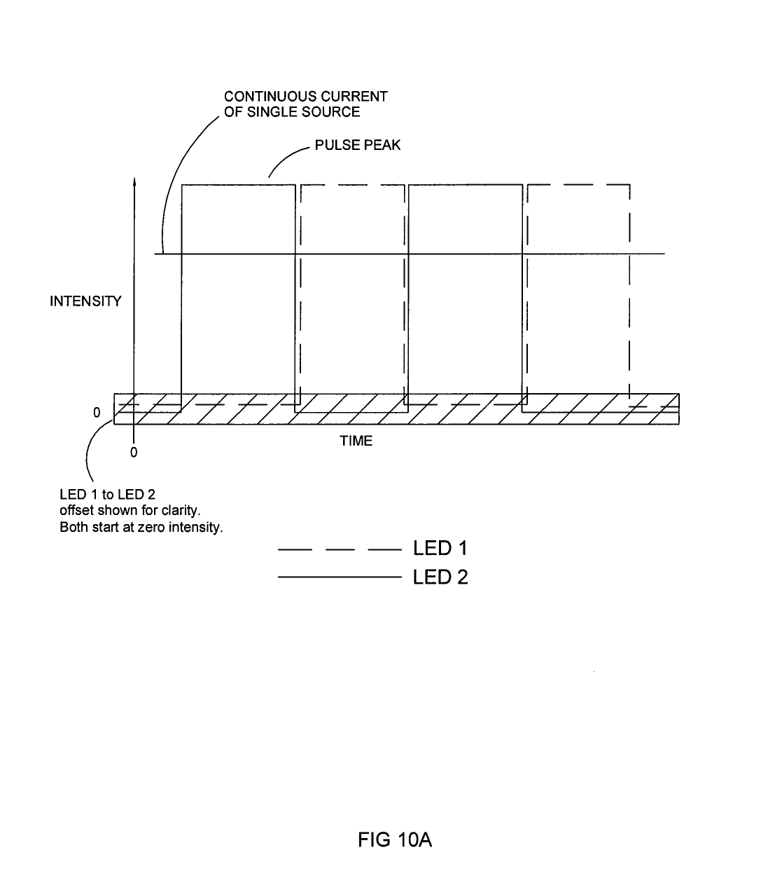

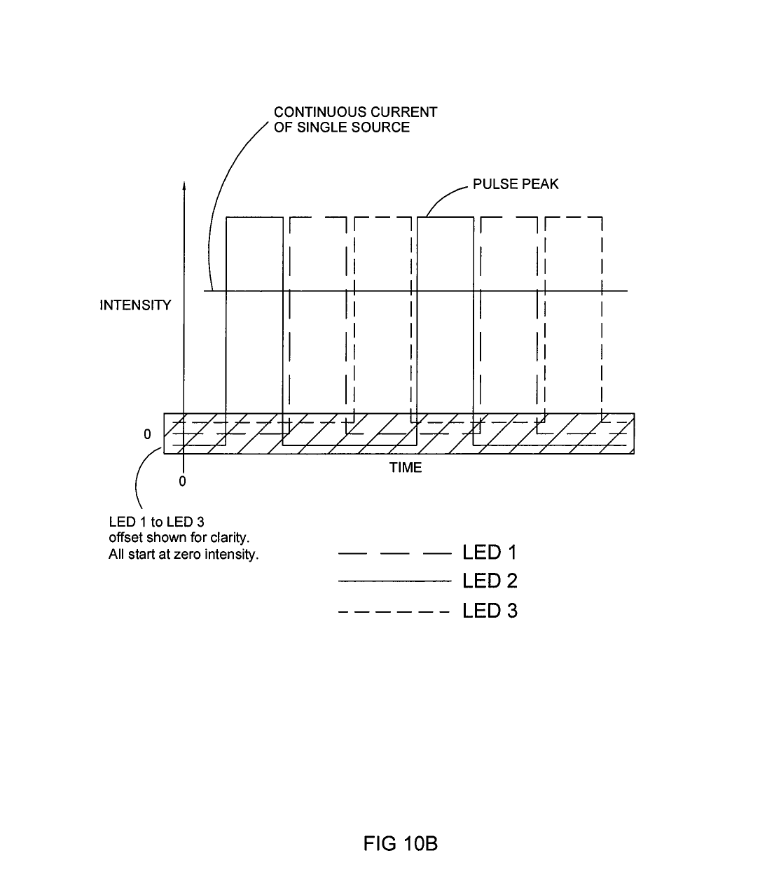

To increase the average intensity, multiple LED sources can be pulsed sequentially such that the combination of the sources represents continuous output. As a general guideline, the duty cycle of each LED source in the system would equal the reciprocal of the number of sources (e.g. two LED sources would provide duty cycle of 50% each, three LED sources 33% each and so on). A more conservative approach may even allow the duty cycles to slightly overlap each other, e.g. three LED source may have a 40% duty cycle to ensure no dead time in the combined operation. FIGS. 10A and 10B illustrate such operation of two and three LED sources respectively. The fact that the LEDs can be driven to higher peak currents for short periods of time, and thus higher intensity, results in the combined pulsed illumination of multiple LEDs being greater than if an individual LED was continually operated.

Methods for pulsing LEDs to increase the light output are known in the art. Two of such methods are discussed in the publication “Increased Lumens per Etendue by Combining Pulsed LED's” by Huesyin Murat, et al, Proceedings of SPIE Volume 5740, which is incorporated herein by reference. In one method discussed, the pulsed LEDs are mounted on a rotating carousel, which passes in front of the optics at the appropriate time (shown in FIG. 5 of the publication). In yet another method, two LEDs are combined with a beam splitter and a switching ½ wave retarder (shown in FIG. 8 of the publication).

A secondary benefit from pulsing is improved thermal management as the distribution of heat is over a larger area, i.e. multiple LEDs. In conjunction with (or as an integral part of) various light recycling embodiments envisioned herein, this type of thermal management can be included in the invention so that complex heat management methods used in related art systems may not be required. In the aspect of the above embodiments, the efficiency of the light output is significantly improved. Thus, pulsing can occur to control the heat and still provide adequate light output for many applications.

Therefore, combining pulsing power management with the light recycling embodiments herein can increase light output, conserve etendue and provide a means of thermal management without the mechanical movement of components. These improvements provide many benefits to the industry.

### K. Alternative Light Sources

The above embodiments are presented in the context of an LED light source with reflective substrate. The reflective substrate, along with the optical assembly, allows the light source to act as a mirror to reflect the light back out of the assembly. In most instances, a secondary LED light source can be replaced with a reflective mirror. This will decrease the intensity of the system by the amount of light contributed by the removed light source, but the polarized light recycling can still take place.

Alternate light sources beyond LED or other solid-state lighting can be used in the above embodiments. FIG. 9A illustrates an arc tube type light source with highly reflective housing. This type of optical design is similar to the LED design and should function in similar manner. Another type of light source envisioned for use with (or as an integral part of) the present invention is laser light. In general, any number of alternate light sources that can be configured to reflect the light back out of the optic system can be used for various embodiments of the present invention.

### L. Alternative Optic Designs

One or more of the above embodiments have envisioned usage of an LED light source with reflective substrate surrounded by a TIR (total internal reflection) collimator with refractive lens over the LED source. (The TIR has been represented generally by an “optic assembly,” above.) However, any number of alternative optic designs can also be applied to the above embodiments, including those shown in FIG. 9B. For example, a refractive element (as shown in alternative design 9004) can be used to direct the light to the reflective substrate of the LED. In this example, the LED is located on the axis of the lens and in the focal plane. Other examples (9002 and 9006) use a metallized reflector with the LED and allows the beam paths to be non-parallel. Design 9008 is an example of a design for reflecting parallel beams.

### M. Alternative Non-Parallel Light Beam Paths

The above embodiments are presented in the context of light beams that travel parallel to the principal axis of the optic system. However, as shown in FIG. 9C, non-parallel beams can also be applied to the embodiments above, possibly in conjunction with an optical homogenizer 96 where appropriate for certain applications.

### N. Applications for the Inventions

There are many different applications that could benefit from this invention. In general, any system that requires single polarized light could be improved by using the aspects of this invention. Some common applications include:

1. LCD display screens using backlight or front projection light.

2. LCoS screens using backlight or front projection light

3. Monitors

4. Digital signs

5. Cinema or film industry

In general, it should be appreciated and understood that the specific embodiments of the invention described hereinbefore are merely illustrative of the general principles of the invention. Since numerous modifications and variations will readily occur to those skilled in the art, it is not desired to limit the invention to the exact construction and operation illustrated and described, and accordingly, all suitable modifications and equivalents may be resorted to. Thus, while the foregoing invention has been described in detail by way of illustration and example, numerous modifications, substitutions, and alterations are also contemplated.

What is claimed is:

1. A method for converting randomly polarized light having a first and second component into singularly polarized light having substantially only said first component, wherein said first and second components are substantially perpendicular to each other, comprising the steps of:
generating, from at least two reflective light engines, randomly polarized light having the first and second components, wherein two or more of said at least two reflective light engines have optic axes that substantially align with one another;
separating the components of the randomly polarized light, and directing light having substantially only said first component in a first direction and directing light having substantially only said second component in a second direction;
sending light having substantially only said first component in a direction for output;
directing said light having substantially only said second component to a component converter, and converting said light having substantially only said second component to converted light having substantially only said first component,
reflecting said converted light using one or more of said at least two reflective light engines; and
sending said converted light in said direction for output.

2. The method of claim 1, wherein at least one of said reflective light engines contains a reflective light source, and comprising the step of using said reflective light source to reflect said converted light.

3. The method of claim 2, wherein the reflective light source is a light emitting diode.

4. The method of claim 1, wherein said step of separating the components comprises the step of using a polarized beam splitter.

5. The method of claim 1, wherein said component converter is a ¼ wave retarder, wherein the light is passed twice through the ¼ wave retarder.

6. A system for converting randomly polarized light having a first and second component into singularly polarized light having substantially only said first component, wherein said first and second components are substantially perpendicular to each other, comprising:
two or more reflective light engines each generating randomly polarized light,
wherein light directed at each of said two or more light engines is reflected back in substantially the same direction from which it was received;
a component separator, said component separator separating the first and second components of the randomly polarized light,
wherein the component separator directs light having substantially only said first component in a first direction and directs light having substantially only said second component in a second direction, and wherein said light having substantially only said first component is sent in a direction for output,
said component separator positioned in optical communication with at least one of said light engines such that said component separator directs light having said second component optically toward at least one of said light engines;
one or more component converters, said one or more component converters capable of converting light having substantially only said first component into light having substantially only said second component, and light having substantially only said second component into light having substantially only said first component;
at least one of said one or more component converters positioned in conjunction with at least one of said reflective light engines to allow light directed to and/or being reflected from said at least one reflective light engine to come in optical communication with said at least one component converter, wherein said at least one component converter converts light having substantially only said second component into converted light having substantially only said first component;
wherein said converted light is sent in said direction for output.

7. The system of claim 6, wherein each of said two or more reflective light engines has a reflective light source.

8. The system of claim 7, wherein each reflective light sources is a light emitting diode.

9. The system of claim 6, wherein each of said two or more reflective light engines comprises an arc tube light source.

10. The system of claim 8, wherein said reflective light sources are pulsed sequentially.

11. The system of claim 10, wherein the duty cycle of each of said reflective light source is based upon the reciprocal of the number of reflective light sources used.

12. The system of claim 6, wherein said component separator is a polarized beam splitter.

13. The system of claim 6, wherein said component converter is a ¼ wave retarder, wherein, for light having substantially only said first component to be converted into light having substantially only said second component or light having substantially only said second component to be converted into light having substantially only said first component, the light is passed twice through the ¼ wave retarder.

14. A system for converting randomly polarized light having a first and second component into singularly polarized light having substantially only said first component, wherein said first and second components are substantially perpendicular to each other, comprising:
two light engines each having a reflective light source generating randomly polarized light,
wherein light directed at each of said reflective light sources is reflected back in substantially the same direction from which it was received;
a component separator, said component separator separating the first and second components of the randomly polarized light,
wherein the component separator directs light having substantially only said first component in a first direction and directs light having substantially only said second component in a second direction, and wherein said light having substantially only said first component is sent in a direction for output,
said component separator positioned in optical communication with each of said light engines such that said component separator directs light having said second component optically toward a light source of at least one of said light engines;
two component converters, each component converter being positioned along the optic axis of at least one light engine, said component converters being capable of converting light having substantially only said first component into light having substantially only said second component, and light having substantially only said second component into light having substantially only said first component;
at least one of said two component converters positioned such that light directed to and/or being reflected from at least one of said reflective light sources is in optical communication with said at least one component converter, wherein said at least one component converter converts light having substantially only said second component into converted light having substantially only said first component;
wherein said converted light is sent in said direction for output.

15. The system of claim 14, wherein each of said two reflective light engines has an optic axis that is in substantial alignment with the optic axis of the other light engine.

16. The system of claim 14, wherein each reflective light sources is a light emitting diode.

17. The system of claim 16, wherein said reflective light sources are pulsed sequentially.

18. The system of claim 17, wherein the duty cycle of each of said reflective light source is based upon the reciprocal of the number of reflective light sources used.

19. The system of claim 14, wherein said component separator is a polarized beam splitter.

20. The system of claim 14, wherein said component converter is a ¼ wave retarder, wherein, for light having substantially only said first component to be converted into light having substantially only said second component or light having substantially only said second component to be converted into light having substantially only said first component, the light is passed twice through the ¼ wave retarder.

21. The system of claim 14, wherein said component separator further directs light having said second component optically toward a mirror.
